(19) United States
(12) Patent Application Publication
(10) Pub. No.: US 2024/0294435 A1
(43) Pub. Date: Sep. 5, 2024

(54) POROUS CERAMIC SUPPORTS, MEMBRANES, METHODS AND USES THEREOF

(71) Applicant: National University of Singapore, Singapore (SG)

(72) Inventors: John Wang, Singapore (SG); Qilin Gu, Singapore (SG); How Yong Ng, Singapore (SG); Tze Chiang Albert Ng, Singapore (SG)

(21) Appl. No.: 18/548,073

(22) PCT Filed: Feb. 21, 2022
(86) PCT No.: PCT/SG2022/050080

§ 371 Date: Aug. 26, 2023

(30) Foreign Application Priority Data
Feb. 21, 2022 (SG) 10202101972V

(51) Int. Cl. C04B 35/117; B01D 17/02; B01D 67/00; B01D 69/10; B01D 71/02; C02F 1/44; C02F 101/32; C04B 35/626; C04B 35/636; C04B 35/64; C04B 38/00; C04B 38/06; C04B 41/00; C04B 41/45; C04B 41/50; C04B 41/52; C04B 41/87; C04B 41/89

(52) U.S. Cl. CPC C04B 35/117; B01D 17/02; B01D 67/00411; B01D 69/108; B01D 71/025; C02F 1/44; C04B 35/6264; C04B 35/62655; C04B 35/6365; C04B 35/64; C04B 38/0054; C04B 38/0645; C04B 41/0072; C04B 41/4539; C04B 41/4578; C04B 41/5031; C04B 41/524; C04B 41/87; C04B 41/89; C02F 2101/32; C04B 2235/3217; C04B 2235/349; C04B 2235/5436; C04B 2235/6021; C04B 2235/606; C04B 2235/6567

(57) ABSTRACT

This disclosure concerns methods of fabricating porous ceramic supports and supported ceramic membranes, comprising mixing a ceramic powder, a clay powder and a binder to form a mixture, kneading the mixture in an aqueous or non-aqueous medium and a humectant to form a ceramic paste, and aging the ceramic paste for at least 24 h. The ceramic powder is about 70 wt % to about 80 wt % in the ceramic paste. The clay powder is about 5 wt % to about 15 wt % in the ceramic paste. The ceramic powder has an average particle size of about 5 μm to about 20 μm. This disclosure also concerns porous ceramic supports and supported ceramic membranes thereof.

### TECHNICAL FIELD

The present invention relates, in general terms, to porous ceramic supports and supported ceramic membranes thereof. The present invention also relates to methods of fabricating porous ceramic supports and supported ceramic membranes.

### BACKGROUND

Porous ceramics are widely used as the supports for catalysts and separation membranes, owing to excellent chemical robustness, large surface area, highly permeation and good mechanical strength. The effects of porous ceramic support on the overall performance have been increasingly recognized, and growing attentions are paid to design and optimize their microstructure and chemistry. In the pressure-driven filtration process, the mechanical strength of ceramic membranes is of significance for their service performance, which is dominated by macro-/micro-porous ceramic supports. At the same time, the ceramic supports are desired to be as porous as possible to minimize the filtration resistance, which is the foundation for highly permeable membranes. The mechanical strength of porous ceramic supports can be improved by increasing the processing temperature. However, this will inevitably reduce the level of porosity and thereby decrease the permeation behaviour. Therefore, it would be highly desirable, yet rather challenging, to overcome the delicate trade-off between the permeation and mechanical strength of porous ceramic supports.

Alumina powders have been widely used to prepare porous ceramic supports, which are also the main components of the commercial ceramic membranes. Since alumina powders for ceramic supports are usually larger in sizes, a high temperature above 1600° C. is required to prepare the macro-/micro-porous support to ensure the acceptable mechanical strength. The relatively high cost of alumina powders and the high-temperature sintering result in the high fabrication cost of ceramic supports, which accounts for the major part of fabrication costs for ceramic membranes. Recently, low-cost natural materials and solid waste have been explored to prepare porous ceramic supports. Given the relatively low melting point of these materials, low-cost ceramic supports can be obtained at a temperature lower to 900° C. However, these low-cost ceramic supports show insufficient mechanical strength and poor chemical stability when compared with the high-purity alumina supports, and their applications would be thus largely limited.

The incorporation of low-cost natural materials into the conventional alumina matrix would be a compromising pathway to obtain the porous ceramic support at lower sintering temperature, and yet with both high mechanical strength and chemical stability. For example, the preparation of clay-alumina supports by using 25 wt % clay and 75 wt % alumina as the raw materials was reported. Through a proper blending, extrusion and sintering at 1350° C. the clay-alumina supports showed a mechanical strength of 37 MPa, and pure water flux of 850 LMHB. The low pure water permeance is mainly related to the small pore size (0.75 μm), although the level of porosity is relative high (48%).

In another example, clay-based ceramic support membrane was fabricated by extrusion technique using kaolin (50 wt %), alumina (30 wt %) and natural zeolite (20 wt %). The porosity level in the support was decreased from 56% to 41% with the increase in firing temperatures (550° C., 750° C. 950° C., and 1150° C.). Similarly, the mean pore size of the resulting ceramic supports declined (1.53, 1.34, 0.88 and 0.59 μm). The ceramic supports prepared at 1150° C. showed a pure water flux of 2245 kg/m² h bar. However, these supports showed poor mechanical strength of 15.7±0.9 MPa.

In another example, the effect of ceramic paste formulation, in which the amount (0, 40, 55, 70, and 85 wt %) of clay in alumina was varied, on the physio-chemical properties of extruded and sintered tube supports. However, with the addition of 55 wt % clay, the ceramic supports fired at 1450° C. showed a porosity level of 44% and average pore size of 1.3 μm with poor pore connectivity, while the pure water permeability was only 540 LMH at 1 bar. It was found that an increasing amount of clay would significantly reduce the water permeability of the ceramic support.

These clay-based supports generally show poor chemical resistance.

Although natural silicates, such as kaolin, have been widely adopted to prepare porous ceramic supports, there still lacks rational design in distribution and control in the amount of silicates used. As a result, the glassy phase derived from kaolin tends to block the pores, which correspondingly sacrifice the level of open porosity and thus the permeation of the ceramic support.

Co-firing of the macro-/micro-porous ceramic support and the membrane layer is highly desirable for high performing ceramic membranes, although it is challenging to be made at lowered sintering temperature and thus low production cost. First of all, the macro-/micro-porous ceramic support generally requires a much higher sintering temperature over that of the membrane layer. The large difference in sintering temperature is the first obstacle for the co-firing of the macro-/micro-porous support and the membrane layers.

A lowered sintering temperature of porous ceramic supports is the essential precondition for their co-firing with the membrane layers. For example, it was shown that by using fly ash with low melting point to prepare the ceramic supports, alumina microfiltration membranes can be prepared by co-firing at 1050° C. However, as mentioned above, the porous ceramic supports made from fly ash exhibit rather poor mechanical strength (<45 MPa), even when they are reinforced by incorporation of mullite fibers. An appropriate matching in drying and sintering shrinkage between the support and membrane layers is another key factor that shall be carefully considered. The large difference in particle sizes between the porous ceramic supports and fine membrane layer will inevitably enlarge their difference in the shrinkage at both drying and sintering stages. As a result, delamination and/or cracks would easily occur in the co-fired single/multi layered membrane.

It would be desirable to overcome or ameliorate at least one of the above-described problems.

### SUMMARY

The present invention is based on the understanding that porous ceramic membrane supports with high mechanical strength and permeation are required for highly permeable ceramic membranes. The water permeation of ceramic supports is largely dependent on its level of open porosity, which is however generally detrimental to the mechanical strength. The inventors have found that low-cost clay nano-flakes or powder (such as kaolin) can be composited with coarser ceramic powders (such as alumina), and multichannel flat-sheet porous ceramic supports can be fabricated by extrusion and subsequent partial sintering. The trade-off between the water permeation and mechanical strength of ceramic membrane supports can be substantially solved through the combined regulation in pore structure and interfaces.

Accordingly, the present invention provides a method of fabricating a ceramic paste for forming a ceramic support, comprising:
a) mixing a ceramic powder, a clay powder and a binder to form a mixture;
b) kneading the mixture in step (a) in an aqueous or non-aqueous medium and a humectant to form a ceramic paste; and
c) aging the ceramic paste for at least 24 h;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

Advantageously, the incorporation of clay powder such as clay nano-flakes in the paste effectively reduces the firing temperature of the resultant porous ceramic support to at least 1200° C.

In some embodiments, the ceramic powder is selected from alumina. SiC, Si₃N₄, silicates. TiO₂ or a combination thereof.

In some embodiments, the clay powder is selected from kaolin, dolomite, coalgangue, kyanite, smectite, illite, chlorite, palygorskite (attapulgite), sepiolite or a combination thereof.

In some embodiments, the clay powder has an average particle size of about 0.05 μm to about 2 μm.

In some embodiments, the binder is carboxymethyl cellulose (CMC), polyvinylalcohol (PVA), polyvinyl butyral (PVB), polyvinyl pyrrolidone (PVP) or a combination thereof.

In some embodiments, the binder is about 2 wt % to about 8 wt % in the ceramic paste.

In some embodiments, the solvent is about 5 wt % to about 20 wt % in the ceramic paste.

In some embodiments, the humectant is glycerol. L-pyrrolidone carboxylic acid-Na, polyhydric alcohol, or a combination thereof.

In some embodiments, the humectant is about 0.1 wt % to about 1.5 wt % in the ceramic paste.

In some embodiments, the ceramic paste is free of a pore forming agent.

In some embodiments, the aging step is performed in an enclosed environment.

In some embodiments, the method further comprises a step (d) (after step (c)) of extruding the ceramic paste in order to form a ceramic green body.

In some embodiments, the method further comprises a step after step (d) of drying the ceramic green body for at least 24 h.

In some embodiments, the extruded green body comprises an asymmetric porous structure having an inner body conterminous to an outer surface; wherein the inner body comprises a plurality of voids.

The present invention also provides a method of fabricating a porous ceramic support from a ceramic paste as disclosed herein, comprising:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h;
d) extruding the aged ceramic paste in order to form a ceramic green body; and
e) at least partially sintering the green body at about 1000° C. to about 1500° C.;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

An interesting evolution of pore structure in the resultant porous ceramic support was evidenced with the increase in firing temperature. Significantly, the porous ceramic supports prepared at 1400° C., showed the high water permeability of 9911.9±357.5 LMHB, and at the same time the flexural strength reached 109.6±4.6 MPa. The improved permeability was attributed to the unique multi-level inter-connected pore structures, and the enhanced flexural strength in the resultant porous ceramic support was mainly originated from the strongly inter-connected ceramic grains, as evidenced by the trans-granular fracture behaviour. Also, the ceramic supports exhibited excellent chemical resistance and good removal efficiency for oily wastewater.

In some embodiments, the ceramic green body is at least partially dried before the sintering step.

In some embodiments, the sintering step is performed for at least 2 h.

In some embodiments, a thickness of the ceramic support decreases by less than about 8% after the sintering step.

The present invention also provides a method of fabricating a supported ceramic membrane from a ceramic paste as disclosed herein, comprising:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h;
d) extruding the aged ceramic paste in order to form a ceramic green body;
e) coating at least one layer of a ceramic slurry on a surface of the ceramic green body and drying the coated layer of ceramic slurry to form a membrane green body; and
f) at least partially sintering the membrane green body and the ceramic green body at about 1000° C. to about 1500° C. to form the supported ceramic membrane;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

In some embodiments, the ceramic slurry comprises ceramic powder at about 10 wt % to about 40 wt % in the slurry.

In some embodiments, the ceramic powder in the ceramic slurry has a particle size of about 0.05 μm to about 5 μm.

In some embodiments, the ceramic slurry comprises nitric acid at a concentration of about 0.01 mol/L to about 0.5 mol/L.

In some embodiments, the ceramic slurry further comprises methyl cellulose at about 1 wt % to about 5 wt % relative to the slurry.

In some embodiments, the step of coating at least one layer of a ceramic slurry on a surface of the green body and drying the coated layer of ceramic slurry to form a membrane green body comprises:
i) coating a first layer of a first ceramic slurry on the surface of the green body and drying the coated layer of the first ceramic slurry to form a first membrane green body, and the first membrane green body having an exposed surface distal from the surface of the green body; and
ii) coating a second layer of a second ceramic slurry on the exposed surface of the first membrane green body and drying the coated layer of the second ceramic slurry to form a second membrane green body.

In some embodiments, the first ceramic slurry comprises ceramic powder having a particle size of about 1 μm to about 5 μm.

In some embodiments, the second layer of ceramic comprises ceramic powder having a particle size of about 0.05 μm to about 1.5 μm.

The present invention also provides a ceramic paste for forming a ceramic support, comprising: a) a ceramic powder at about 70 wt % to about 80 wt % in the ceramic paste;
b) a clay powder at about 5 wt % to about 15 wt % in the ceramic paste;
c) a binder at about 2 wt % to about 8 wt % in the ceramic paste;
d) a humectant at about 0.1 wt % to about 1.5 wt % in the ceramic paste; and
e) an aqueous medium;
wherein the ceramic powder has an average particle size of about 5 μm to about 20 μm.

In some embodiments, the ceramic paste has a viscosity of about 1×10⁴ Pa·s to about 5×10+Pa·s at a shear rate of about 10⁻¹ s⁻¹.

In some embodiments, the ceramic paste has a yield flow pressure of about 1000 Pa to about 1500 Pa.

The present invention also provides a ceramic green body of a ceramic support, comprising:
a) a ceramic powder at about 80 wt % to about 90 wt % in the green body;
b) a clay powder at about 5 wt % to about 15 wt % in the green body;
c) a binder at about 2 wt % to about 8 wt % in the green body; and
d) a humectant at about 0.1 wt % to about 1.5 wt % in the green body;
wherein the ceramic powder has an average particle size of about 5 μm to about 20 μm.

The present invention also provide a ceramic support fabricated from a ceramic green body as disclosed herein, comprising:
a) a ceramic at about 85 wt % to about 95 wt % in the ceramic support; and
b) a clay at about 5 wt % to about 15 wt % in the ceramic support;
wherein the ceramic has an average particle size of about 5 μm to about 20 μm; and
wherein the ceramic support comprises an asymmetric porous structure having an inner body conterminous to an outer surface;
wherein the inner body further comprises a plurality of voids.

In some embodiments, the ceramic support has a porosity of about 30% to about 50%.

In some embodiments, the ceramic support has a pore size distribution of about 0.3 μm to about 3.5 μm.

In some embodiments, the ceramic support has a multimodal pore size distribution.

In some embodiments, when the clay is kaolinite, the clay has a phase composition comprising of mullite, cristobalite, or a combination thereof.

In some embodiments, the void has a diameter of about 0.5 μm to about 100 μm.

In some embodiments, the outer surface has a thickness of about 40 μm to about 100 μm.

The present invention also provides a supported ceramic membrane fabricated from a ceramic green body of a ceramic membrane as disclosed herein, comprising:
a) a porous ceramic support fabricated from the ceramic green body; and
b) at least one ceramic membrane layer coated on a surface of the porous ceramic support.

In some embodiments, the ceramic membrane has a thickness of about 3 μm to about 100 μm.

In some embodiments, at least two ceramic membrane layers are coated on the surface of the porous ceramic support to form a multilayered membrane structure.

In some embodiments, each of the at least two ceramic membrane layers comprises ceramic particles with a different particle size.

In some embodiments, the ceramic membrane has a retention for 20 nm particles of at least about 50%.

### BRIEF DESCRIPTION OF THE DRAWINGS

Embodiments of the present invention will now be described, by way of non-limiting example, with reference to the drawings in which:

FIG. 1 illustrates scanning electron microscopy (SEM) and X-ray diffraction (XRD) characterization of exemplary raw materials;

FIG. 2 illustrates rheology properties of an exemplary ceramic paste (Alumina):

FIG. 3 illustrates microstructure, thermal behaviour, and phase composition of the extruded green body of ceramic support after drying at room temperature for 48 h:

FIG. 4 illustrates (a) level of open porosity, and (b) thickness and shrinkage of the ceramic supports prepared at different temperatures:

FIG. 5 illustrates pore size distribution of ceramic supports prepared at different temperatures:

FIG. 6 illustrates surface SEM images of ceramic supports prepared at various temperatures:

FIG. 7 illustrates compositional analysis of an exemplary ceramic support prepared at 1400° C.:

FIG. 8 illustrates a schematic representation of the microstructure evolution of kaolin-alumina ceramic support with the increasing of calcination temperature:

FIG. 9 illustrates water permeability of the ceramic supports prepared at different temperatures:

FIG. 10 illustrates cross-sectional microstructure of ceramic supports and illustrations of the velocity distribution and the pressure distribution of the ceramic paste in pressure die during the extrusion process:

FIG. 11 illustrates schematics of the asymmetric structure of the flat-sheet ceramic support, and the flexural strength in different models and flexural strength of the ceramic support prepared at 1400° C.:

FIG. 12 illustrates microstructure and elemental distribution of fracture surface of ceramic supports fired at different temperatures:

FIG. 13 illustrates physical properties and fracture microstructure of ceramic supports after corroded in NaOH (10 wt %) and H₂SO₄ (20 wt %) aqueous solution for 20 h:

FIG. 14 illustrates filtration performance and fouling mechanism of the ceramic membrane supports in oily wastewater treatment:

FIG. 15 illustrates surface SEM images of single-layered membrane co-fired at various temperatures:

FIG. 16 illustrates SEM images of fracture surface of single-layer membrane co-fired at various temperatures:

FIG. 17 illustrates particle size retention of ceramic membranes co-fired at different temperatures measured using polystyrene latex nanospheres of various sizes (20 nm. 30 nm. 40 nm. 50 nm and 70 nm):

FIG. 18 illustrates an SEM image of a fractured single-layer membrane co-fired at 1400° C.; and

FIG. 19 illustrates microstructure of the gradient multilayered membranes co-fired at 1400° C.

### DETAILED DESCRIPTION

The high fabrication cost of ceramic membranes is one of the obstacles for their wide application. In particular, the common macro-porous ceramic support requires a high temperature (1600° C.) in order to obtain an adequate mechanical strength, which is among the key considerations for their functions in ceramic membranes. Traditional approaches (involving the addition of low-cost natural materials in ceramic support fabrication) commonly cause the discount in physical properties, such as mechanical strength, corrosion resistance, level of porosity and permeation.

From a review of the prior art, the inventors have realised that previous works have mainly attempted to reduce the sintering temperature to improve the properties of the ceramic supports, by using relatively high amounts of clay (25˜85 wt %). As a result, the obtained ceramic supports showed a relatively low level of porosity, insufficient permeability and largely sacrificed mechanical strength. Without wanting to be bound by theory, it is believed that the trade-off between the water permeation and mechanical strength of ceramic membrane supports can be substantially solved through the combined regulation in pore structure and interfaces. Towards this end, the inventors have regulated the amount and distribution of clay nanoflakes (kaolin) in the coarse alumina matrix, aiming at developing a class of alumina-clay ceramic supports with both high water permeation and high mechanical strength. With the decoration of clay nanoflakes on the surface and at the interfaces, the coarse alumina particles can be strongly bonded together at lowered temperatures. At the same time, the additives between the coarse alumina particles can enlarge the spacing between adjacent particles, and improve the pore size and thereby permeability. Multichannel flat-sheet ceramic supports were purposely designed and fabricated in order to prepare ceramic membranes for membrane bioreactors (MBRs), an emerging hybrid technique with the combination of membrane filtration and biological treatment for wastewater treatment.

By doing so, a reduction in the fabrication cost of ceramic support through the use of lost cost materials and lower sintering temperature can be used, which at the same time provides for an improvement in the mechanical strength and permeation. The liquid phase derived from well-distributed clay nanoflakes accumulates at the necks/boundaries of ceramic particles, thereby lowering the sintering temperature and enhancing the partial sintering, which can be achieved at lowered sintering temperature. At the same time, the pores in the ceramic support is well maintained, giving rise to the desired combination of a high level of porosity and mechanical strength being significantly improved. Since the sintering temperature of the macro-porous support is reduced, thereby reducing the overall production cost of ceramic membranes.

Further, the sintering temperature of the macro-porous supports matches well with those of the membrane layers, which is among the consideration for the successful co-firing process. The functional gradient structure constructed by the co-firing of layers with different sized particles minimize the shrinkage difference among the adjacent layers, the risk of delamination and cracks is effectively eliminated, which ensures the membrane integrity in the co-firing process. Moreover, such a gradient membrane structure is shown to be superior in filtration performance in terms of water flux and fouling retarding ability, compared to the single layered membrane.

Accordingly, the present invention provides a method of fabricating a ceramic paste for forming a ceramic support, comprising:
a) mixing a ceramic powder, a clay powder and a binder to form a mixture;
b) kneading the mixture of step (a) in an aqueous or non-aqueous medium and a humectant to form a ceramic paste; and
c) aging the ceramic paste for at least 24 h;
wherein the ceramic powder is about 70 wt % to about 80 wt % in the green body;
wherein the clay powder is about 5 wt % to about 15 wt % in the green body; and
wherein the ceramic powder has an average particle size of about 5 μm to about 20 μm.

In some embodiments, the method of fabricating a ceramic paste for forming a ceramic support, comprises:
a) mixing a ceramic powder, a clay powder and a binder to form a mixture;
b) kneading the mixture of step (a) in an aqueous or non-aqueous medium and a humectant to form a ceramic paste; and
c) aging the ceramic paste for at least 24 h;
wherein the ceramic powder is about 70 wt % to about 80 wt % in the green body;
wherein the clay powder is about 5 wt % to about 15 wt % in the green body; and
wherein the ceramic powder has an average particle size of about 6 μm to about 20 μm.

As used herein. ‘ceramic paste’ refers to a mixture of ceramic powders, binders and solvents prepared by mixing, kneading and age treatment for a period of time. The paste can further comprise a solvent, to allow the paste to obtain a semi solid state and be more malleable.

‘Green body’ refers to a ceramic paste after it is being shaped into a specific configuration, for example, by using extrusion. A ceramic green body is an object whose main constituent is weakly bound ceramic particles, usually in the form of bonded powder or plates before it is sintered or fired. In ceramic processing, the most common method for producing ceramic components is to form a green body comprising a mixture of the ceramic material and various organic or inorganic additives, and then to sinter it in a furnace to produce a strong and well-jointed object. Additives can serve as solvents, dispersants, binders, plasticizers, lubricants, or wetting agents.

‘Porous ceramic support’ refers to a ceramic article that is obtained by at least partial sintering of the extruded green body at high temperatures.

‘Ceramic membrane’ refers to a single-layered or multilayered structure formed from ceramic particles, which is porous and thus can be used as a selective barrier for filtration and separation. Corollary, a “supported ceramic membrane” refers to a single-layered or multilayered structure formed from ceramic particles which is supported on a support or platform. The support can be a ceramic support. For example, the ceramic membrane can be formed by coating a ceramic slurry on the ceramic support (or green body) and followed by partial sintering.

In some embodiments, the mixing and/or kneading steps are performed at room temperature and atmospheric pressure. In other embodiments, the steps are performed at about 15° C. to about 35° C. about 15° C. to about 30° C. about 15° C. to about 25° C. or about 20° C. to about 25° C. In other embodiments, the mixing and kneading steps are performed at atmospheric pressure. In other embodiments, the steps are performed at about 80 Pa to about 120 Pa, about 90 Pa to about 120 Pa, about 90 Pa to about 110 Pa. or about 100 Pa to about 110 Pa.

In some embodiments, the ceramic powder is a crystalline ceramic or a non-crystalline ceramic. In other embodiments, the ceramic powder is selected from an oxide, nitride, carbide materials, or a combination thereof. In other embodiments, the ceramic powder is selected from alumina (aluminium oxide). In other embodiments, the ceramic powder is selected from silicon carbide, titanium carbide, barium titanate, boron carbide, iron oxide and tungsten carbide. In other embodiments, the ceramic powder is selected from alumina. SiC, Si₃N₄, silicates. TiO₂ or a combination thereof.

In some embodiments, the ceramic support is formed from a ceramic powder or ceramic particles. In other embodiments, the ceramic powder has an average particle size of about 5 μm to about 20 μm, or about 6 μm to about 20 μm. In other embodiments, the average particle size is about 5 μm to about 18 μm, about 5 μm to about 16 μm, about 5 μm to about 15 μm, about 5 μm to about 14 μm, about 5 μm to about 13 μm, about 5 μm to about 12 μm, about 6 μm to about 12 μm, about 7 μm to about 12 μm, about 8 μm to about 12 μm, or about 9 μm to about 12 μm. In other embodiments, the ceramic powder has an average particle size of about 6 μm to about 20 μm, about 7 μm to about 20 μm, about 8 μm to about 20 μm, about 9 μm to about 20 μm, or about 10 μm to about 20 μm.

Advantageously, it was found that ceramic powder with an appropriate particle sizes is used, a desirable porosity can be obtained as provided by the pores between particles. This is due to the desired stacking of the coarse ceramic powder particles. At the same time, a good flexural strength is maintained by the three dimensional networks formed by inter-connected particles.

In some embodiments, the ceramic powder has an asymmetrical morphology. In other embodiments, the ceramic powder has a plate-like morphology. Accordingly, in some embodiments, when the ceramic powder consists of alumina particles having a plate like morphology, a width of the alumina particle is about 5 μm to about 20 μm, and a height of the alumina particle is about 1 μm to about 6 μm, about 1 μm to about 5 μm, or about 2 μm to about 5 μm.

In some embodiments, the clay powder is hydrous aluminium phyllosilicate. In other embodiments, the clay powder is selected from the group of kaolin, smectite, illite, chlorite, palygorskite (attapulgite), sepiolite, or a combination thereof. In other embodiments, the clay powder is selected from kaolin, dolomite, coalgangue, kyanite, smectite, illite, chlorite, palygorskite (attapulgite), sepiolite or a combination thereof.

Kaolin group includes the minerals kaolinite, dickite, halloysite, and nacrite (polymorphs of Al₂Si₂O₅(OH)₄). Smectite group includes dioctahedral smectites, such as montmorillonite, nontronite and beidellite, and trioctahedral smectites, such as saponite. Illite group includes the clay-micas and other minerals which contains illite. Chlorite group includes a wide variety of similar minerals with considerable chemical variation.

In other embodiments, the clay powder is kaolinite.

In some embodiments, the clay is formed from a powder. In other embodiments, the powder has an average particle size of about 0.05 μm to about 2 μm, or about 0.1 μm to about 2 μm. In other embodiments, the average particle size is about 0.05 μm to about 1.8 μm, about 0.05 μm to about 1.6 μm, about 0.05 μm to about 1.5 μm, about 0.1 μm to about 1.5 μm, about 0.1 μm to about 1.4 μm, about 0.1 μm to about 1.3 μm, about 0.1 μm to about 1.2 μm, about 0.1 μm to about 1.1 μm, about 0.2 μm to about 1.1 μm, about 0.3 μm to about 1.1 μm, about 0.4 μm to about 1.1 μm, about 0.5 μm to about 1.1 μm, about 0.6 μm to about 1.1 μm, or about 0.7 μm to about 1.1 μm.

In some embodiments, the clay powder has an asymmetrical morphology. In other embodiments, the clay powder has a plate like morphology. Accordingly, in some embodiments, when the clay powder is a kaolinite particle having a plate like morphology, a width of the alumina particle is about 0.1 μm to about 1.8 μm, and a height of the kaolinite particle is about 0.01 μm to about 1 μm, about 0.01 μm to about 0.5 μm, or about 0.01 μm to about 0.1 μm.

When sintered at a high temperature, the clay powder particle being of a smaller size than the ceramic powder particle can migrate from the surface of the ceramic powder particle to the interface of the ceramic powder particles. In this way, the clay powder can act as a binder for connecting the ceramic particles, hence improving the mechanical strength. For example, kaolin can additionally transform to metakaolin and SiO₂, which tend to diffuse and accumulate at the interface/junctions of alumina particles.

In some embodiments, a particle size ratio of ceramic powder to clay powder is about 3:1 to about 200:1. In other embodiments, the particle size ratio is about 3:1 to about 180:1, about 3:1 to about 160:1, about 3:1 to about 140:1, about 3:1 to about 120:1, about 3:1 to about 100:1, about 3:1 to about 80:1, about 3:1 to about 60:1, about 3:1 to about 50:1, about 3:1 to about 40:1, about 3:1 to about 30:1, about 3:1 to about 20:1, or about 3:1 to about 10:1.

A binder is any material or substance that holds or draws other materials together to form a cohesive whole mechanically, chemically, by adhesion or cohesion. In some embodiments, the binder is carboxymethyl cellulose (CMC), polyvinylalcohol (PVA), polyvinyl butyral (PVB), polyvinyl pyrrolidone (PVP) or a combination thereof.

In some embodiments, the binder is about 2 wt % to about 8 wt % in the ceramic paste. In other embodiments, the weight ratio is about 2 wt % to about 7 wt %, about 2 wt % to about 6 wt %, about 3 wt % to about 6 wt %, about 3 wt % to about 5 wt %, or about 4 wt % to about 5 wt %.

In some embodiments, the solvent is an aqueous medium. The term ‘aqueous medium’ used herein refers to a water based solvent or solvent system (or mixture), which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water.

In some embodiments, the solvent is a non-aqueous medium. The term ‘non-aqueous medium’ used herein refers to an organic based solvent or solvent system (or mixture), which comprises of mainly of an organic solvent (i.e. not water). Organic based solvents can be any carbon based solvents. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Organic based solvents or solvent systems can include, but not limited to, any non-polar liquid which can be hydrophobic and/or lipophilic.

As such, oils such as animal oil, vegetable oil, petrochemical oil, and other synthetic oils are also included within this definition.

In some embodiments, the solvent is about 5 wt % to about 20 wt % in the ceramic paste. In other embodiments, the weight ratio is about 5 wt % to about 18 wt %, about 5 wt % to about 16 wt %, about 5 wt % to about 14 wt %, about 5 wt % to about 12 wt %, about 5 wt % to about 10 wt %, about 6 wt % to about 10 wt %, or about 7 wt % to about 10 wt %.

A humectant is a hygroscopic substance used to keep things moist. In some embodiments, the humectant is glycerol. L-pyrrolidone carboxylic acid-Na, polyhydric alcohol, or a combination thereof. In some embodiments, the humectant is glycerol.

In some embodiments, the humectant is about 0.1 wt % to about 1.5 wt % in the ceramic paste. In other embodiments, the weight ratio is about 0.1 wt % to about 1.4 wt %, about 0.1 wt % to about 1.3 wt %, about 0.1 wt % to about 1.2 wt %, about 0.1 wt % to about 1.1 wt %, about 0.1 wt % to about 1.0 wt %, about 0.1 wt % to about 0.9 wt %, about 0.1 wt % to about 0.8 wt %, about 0.1 wt % to about 0.7 wt %, about 0.1 wt % to about 0.6 wt %, or about 0.1 wt % to about 0.5 wt %.

In some embodiments, the aging step is performed in an enclosed environment. In this regard, the aging step is performed in a sealed environment. By doing so, the volatile solvent is not lost, which can cause the green body to dry out and be usable for extrusion. Aging treatment of the ceramic paste can help improve the uniformity and the plasticity of the ceramic paste.

In some embodiments, the aging step is performed at room temperature and atmospheric pressure. In other embodiments, the step is performed at about 15° C. to about 35° C. about 15° C. to about 30° C. about 15° C. to about 25° C. or about 20° C. to about 25° C. In other embodiments, the aging step is performed at atmospheric pressure. In other embodiments, the step is performed at about 80 Pa to about 120 Pa, about 90 Pa to about 120 Pa, about 90 Pa to about 110 Pa, or about 100 Pa to about 110 Pa.

In some embodiments, the method further comprises a step (d) of shaping the ceramic paste. The ceramic paste can for example be shaped by hand or by an extrusion device. In other embodiments, the method further comprises a step (d) (after step (c)) of extruding the ceramic paste. The ceramic paste is extruded to form a green body. Extrusion is a process used to create objects of a designed shape, dimensions and sizes. The ceramic green body can be formed by extruding ceramic paste through a die of the desired cross-sections.

In some embodiments, the green body is extruded at about 20 bar to about 40 bar. In other embodiments, the pressure is about 20 bar to about 35 bar, about 20 bar to about 30 bar, or about 20 bar to about 25 bar.

In some embodiments, the green body is at least partially dried before the sintering step. In some embodiments, the method further comprises a step after step (d) of drying the extruded green body for at least 24 h. The drying step allows water within the green body to evaporate, thus providing a more rigid structure for ease of handling. In some embodiments, after the green body is at least partially dried, the aqueous or non-aqueous medium is less than about 6 wt %. In other embodiments, the aqueous or non-aqueous medium is less than about 5 wt %, about 4 wt %, about 3 wt %, about 2 wt %, or about 1 wt %. The amount of solvent can be determined from the TGA curve, based on the weight loss in the temperature range of 25° C.-150° C.

In some embodiments, the drying is performed at room temperature and atmospheric pressure. In other embodiments, the step is performed at about 15° C. to about 35° C. about 15° C. to about 30° C. about 15° C. to about 25° C. or about 20° C. to about 25° C. In other embodiments, the drying is performed at atmospheric pressure. In other embodiments, the step is performed at about 80 Pa to about 120 Pa, about 90 Pa to about 120 Pa, about 90 Pa to about 110 Pa, or about 100 Pa to about 110 Pa. Alternatively, the drying can be performed at elevated temperatures, for example, about 30° C. to about 100° C. about 40° C. to about 100° C. about 50° C. to about 100° C. about 60° C. to about 100° C. about 70° C. to about 100° C. or about 80° C. to about 100° C.

In some embodiments, a pore forming agent is not used. A pore forming agent is usually used for improving a membrane's permeation properties, by increasing the polymer viscosity, creating a spongy membrane structure by prevention of macrovoid formation, improving the level of porosity or enhancing the pore interconnectivity when added in appropriate amounts. Examples of pore forming agents are, but not limited to, soluble starch, graphite and activated carbon.

In some embodiments, the method of fabricating a ceramic paste, comprises:
a) mixing alumina, kaolin and carboxymethyl cellulose (CMC) to form a mixture;
b) kneading the mixture in step (a) in an aqueous or non-aqueous medium and a humectant to form a ceramic paste;
c) aging the ceramic paste for at least 24 h;
wherein the alumina is about 75 wt % in the ceramic paste;
wherein the kaolin is about 8 wt % in the ceramic paste; and
wherein the alumina has an average particle size of about 5 μm to about 20 μm.

In some embodiments, the method of fabricating a ceramic paste, comprises:
a) mixing alumina, kaolin and carboxymethyl cellulose (CMC) to form a mixture;
b) kneading the mixture in step (a) in an aqueous or non-aqueous medium and a humectant to form a ceramic paste;
c) aging the ceramic paste for at least 24 h;
wherein the alumina is about 75 wt % in the ceramic paste;
wherein the kaolin is about 8 wt % in the ceramic paste;
wherein the CMC is about 4 wt % in the ceramic paste; and
wherein the alumina has an average particle size of about 5 μm to about 20 μm.

In some embodiments, the method of fabricating a ceramic paste, comprises:
a) mixing alumina, kaolin and carboxymethyl cellulose (CMC) to form a mixture;
b) kneading the mixture in step (a) in an aqueous medium and glycerol to form a ceramic paste;
c) aging the ceramic paste for at least 24 h;
wherein the alumina is about 75 wt % in the ceramic paste;
wherein the kaolin is about 8 wt % in the ceramic paste;
wherein the CMC is about 4 wt % in the ceramic paste; and
wherein the alumina has an average particle size of about 5 μm to about 20 μm.

In some embodiments, the method of fabricating a ceramic paste, comprises:
a) mixing alumina, kaolin and carboxymethyl cellulose (CMC) to form a mixture;
b) kneading the mixture in step (a) in an aqueous medium and glycerol to form a ceramic paste;
c) aging the ceramic paste for at least 48 h;
wherein the alumina is about 75 wt % in the ceramic paste;
wherein the kaolin is about 8 wt % in the ceramic paste;
wherein the CMC is about 4 wt % in the ceramic paste; and
wherein the alumina has an average particle size of about 6 μm to about 20 μm.

The present invention also provides a method of fabricating a green body, comprising:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h; and
d) extruding the aged ceramic paste in order to form a green body;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

The present invention also provides a method of fabricating a porous ceramic support from a ceramic paste as disclosed herein, comprising:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h;
d) extruding the aged ceramic paste in order to form a ceramic green body; and
e) at least partially sintering the green body at about 1000° C. to about 1500° C.;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

In some embodiments, the extruded ceramic green body comprises an outer surface and an inner body. In some embodiments, the extruded green body comprises an asymmetric porous structure, where large pores exist in the inner part of the extruded green body. In some embodiments, the extruded green body comprises an inner body conterminous to an outer surface, wherein the inner body comprises a plurality of voids. In this regard, the inner structure and the outer surface shares a common boundary. The voids are formed from air pockets via the extrusion process. The inner body also comprises pores formed from the sintering process of ceramic particles and clay particles.

In some embodiments, the method of fabricating a porous ceramic support from a ceramic paste as disclosed herein, comprises:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h;
d) extruding the aged ceramic paste in order to form a ceramic green body;
e) drying the extruded green body for at least 24 h; and
f) at least partially sintering the dried green body at about 1000° C. to about 1500° C.;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

In some embodiments, the ceramic powder has an average particle size of about 6 μm to about 20 μm.

Sintering is the process of compacting and forming a solid mass of material by heat or pressure without melting it to the point of liquefaction. Sintering can happen in a manufacturing process used with metals, ceramics, and other materials. The atoms in the materials diffuse across the boundaries of the particles, fusing the particles together and creating one solid piece with or without pores between particles. In partial sintering, the process is completed before densification and therefore, the porosity forms in the space remaining between the necked grains.

In some embodiments, the sintering is at about 1000° C. to about 1450° C. about 1050° C. to about 1450° C. about 1050° C. to about 1400° C. or about 1100° C. to about 1400° C.

In some embodiments, the sintering step is performed for at least about 2 h. In other embodiments, the sintering step is performed for at least about 2.5 h, at least about 3 h, at least about 3.5 h, at least about 4 h, or at least about 5 h. In other embodiments, the sintering step is performed for about 2 h to about 24 h. about 2 h to about 22 h, about 2 h to about 20 h, about 2 h to about 18 h, about 2 h to about 16 h, about 2 h to about 14 h, about 2 h to about 12 h, about 2 h to about 10 h, about 2 h to about 8 h, about 2 h to about 6 h, or about 2 h to about 4 h.

In some embodiments, the sintering step is performed with a ramping rate of about 1° C./min to about 5° C./min. In other embodiments, the ramping rate is about 1° C./min to about 4° C./min, about 1° C./min to about 3° C./min, or about 1° C./min to about 2° C./min.

In some embodiments, a weight loss of about 5% to about 10 wt % is obtainable at about 800° C., under thermogravimetric analysis (TGA). This is a result of removal of solvents and organics such as additives. Accordingly, what is left behind is the ceramic powder and clay powder, which has a higher liquefaction temperature. In other embodiments, the weight loss is about 5% to about 9 wt %, about 5% to about 8 wt %, about 5% to about 7 wt %, or about 5% to about 6 wt %.

In some embodiments, a thickness of the ceramic support decreases by less than about 8% after the sintering step. In other embodiments, the thickness decreases by less than about 7%, about 6%, about 5%, or about 4%.

In some embodiments, the thickness of the ceramic support is about 500 μm to about 3000 μm. In other embodiments, the thickness of the ceramic support is about 600 μm to about 3000 μm, about 700 μm to about 3000 μm, about 800 μm to about 3000 μm, about 900 μm to about 3000 μm, about 1000 μm to about 3000 μm, about 1000 μm to about 2800 μm, about 1000 μm to about 2600 μm, about 1000 μm to about 2400 μm, about 1000 μm to about 2200 μm, about 1000 μm to about 2000 μm, about 1000 μm to about 1800 μm, or about 1400 μm to about 1800 μm. In other embodiments, the thickness of the ceramic support is about 1600 μm.

In some embodiments, the method of fabricating a porous ceramic support from a ceramic paste as disclosed herein, comprises:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h;
d) extruding the aged ceramic paste in order to form a ceramic green body;
e) drying the extruded green body for at least 24 h; and
f) at least partially sintering the dried green body at about 1000° C. to about 1500° C.;
wherein the ceramic powder is about 70 wt % to about 80 wt % in the ceramic paste;
wherein the clay powder is about 5 wt % to about 15 wt % in the ceramic paste;
wherein the ceramic powder has an average particle size of about 5 μm to about 20 μm; and
wherein the extruded green body comprises an asymmetric porous structure with larger pores in an inner body relative to an outer surface.

In some embodiments, the method of fabricating a porous ceramic support from a ceramic paste as disclosed herein, comprises:
a) mixing alumina, kaolin and carboxymethyl cellulose (CMC) to form a mixture;
b) kneading the mixture in step (a) in an aqueous or non-aqueous medium and a humectant to form a ceramic paste;
c) aging the ceramic paste for at least 24 h;
wherein the alumina is about 75 wt % in the ceramic paste;
wherein the kaolin is about 8 wt % in the ceramic paste; and
wherein the alumina has an average particle size of about 5 μm to about 20 μm.

In some embodiments, the method of fabricating a porous ceramic support from a ceramic paste as disclosed herein, comprises:
a) mixing alumina, kaolin and carboxymethyl cellulose (CMC) to form a mixture;
b) kneading the mixture in step (a) in an aqueous or non-aqueous medium and a humectant to form a ceramic paste;
c) aging the ceramic paste for at least 24 h;
wherein the alumina is about 75 wt % in the ceramic paste;
wherein the kaolin is about 8 wt % in the ceramic paste;
wherein the CMC is about 4 wt % in the ceramic paste; and wherein the alumina has an average particle size of about 5 μm to about 20 μm.

In some embodiments, the method of fabricating a porous ceramic support from a ceramic paste as disclosed herein, comprises:
a) mixing alumina, kaolin and carboxymethyl cellulose (CMC) to form a mixture;
b) kneading the mixture in step (a) in an aqueous medium and glycerol to form a ceramic paste;
c) aging the ceramic paste for at least 24 h;
wherein the alumina is about 75 wt % in the ceramic paste;
wherein the kaolin is about 8 wt % in the ceramic paste;
wherein the CMC is about 4 wt % in the ceramic paste; and
wherein the alumina has an average particle size of about 6 μm to about 20 μm.

In some embodiments, the method of fabricating a porous ceramic support from a ceramic paste as disclosed herein, comprises:
a) mixing alumina, kaolin and carboxymethyl cellulose (CMC) to form a mixture;
b) kneading the mixture in step (a) in an aqueous medium and glycerol to form a ceramic paste;
c) aging the ceramic paste for at least 48 h; c)
wherein the alumina is about 75 wt % in the ceramic paste;
wherein the kaolin is about 8 wt % in the ceramic paste;
wherein the CMC is about 4 wt % in the ceramic paste; and
wherein the alumina has an average particle size of about 6 μm to about 20 μm.

In some embodiments, the method of fabricating a porous ceramic support from a ceramic paste as disclosed herein, comprises:
a) mixing alumina, kaolin and carboxymethyl cellulose (CMC) to form a mixture;
b) kneading the mixture in step (a) in an aqueous medium and glycerol to form a ceramic paste;
c) aging the ceramic paste for at least 48 h;
d) extruding the aged ceramic paste in order to form a ceramic green body;
e) drying the extruded ceramic green body for at least 48 h; and
f) at least partially sintering the dried ceramic green body at about 1000° C. to about 1500° C.;
wherein the alumina is about 75 wt % in the ceramic paste;
wherein the kaolin is about 8 wt % in the ceramic paste;
wherein the CMC is about 4 wt % in the ceramic paste; and
wherein the alumina has an average particle size of about 6 μm to about 20 μm.

The present invention also provides a method of fabricating a supported ceramic membrane from a ceramic paste as disclosed herein, comprising:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h;
d) extruding the aged ceramic paste in order to form a ceramic green body;
e) coating at least one layer of a ceramic slurry on a surface of the ceramic green body and drying the coated layer of ceramic slurry to form a membrane green body; and
f) at least partially sintering the membrane green body and the ceramic green body at about 1000° C. to about 1500° C. to form the supported ceramic membrane;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

A slurry is a mixture of solids denser than water suspended in liquid. The liquid can be an aqueous medium. The size of solid particles may vary from less than 1 micron up to hundreds of millimeters. The particles may settle below a certain transport velocity and the mixture can behave as a Newtonian or non-Newtonian fluid.

Advantageously, by coating the ceramic slurry on the surface of the green body, when co-fired, a ceramic membrane can be formed on the ceramic support at the same time. This reduces fabrication cost and time, and as well provide for an integrated ceramic membrane with better stability and reduced delamination.

In some embodiments, the ceramic slurry is spray-coated onto the surface of the green body.

In some embodiments, the ceramic slurry comprises ceramic powder at about 10 wt % to about 40 wt % relative to the slurry. In other embodiments, the weight ratio is about 10 wt % to about 35 wt %, about 10 wt % to about 30 wt %, about 10 wt % to about 25 wt %, about 10 wt % to about 20 wt %, or about 10 wt % to about 15 wt %.

In some embodiments, the ceramic powder in the ceramic slurry has a particle size of about 0.05 μm to about 5 μm, or about 0.1 μm to about 5 μm. In other embodiments, the particle size is about 0.05 μm to about 4.5 μm, about 0.1 μm to about 4.5 μm, about 0.1 μm to about 4 μm, about 0.5 μm to about 4 μm, about 1 μm to about 4 μm, about 1 μm to about 3.5 μm, about 1 μm to about 3 μm, or about 1 μm to about 2.5 μm.

In some embodiments, the ceramic slurry comprises nitric acid at a concentration of about 0.01 mol/L to about 0.5 mol/L. In other embodiments, the concentration is about 0.01 mol/L to about 0.4 mol/L, about 0.01 mol/L to about 0.3 mol/L, about 0.01 mol/L to about 0.2 mol/L, or about 0.01 mol/L to about 0.1 mol/L.

In some embodiments, the ceramic slurry further comprises methyl cellulose at about 1 wt % to about 5 wt % relative to the slurry. In other embodiments, the weight ratio is about 1 wt % to about 4 wt %, about 1 wt % to about 3 wt %, or about 1 wt % to about 2 wt %.

The thickness of the ceramic membrane can be about 0.5 μm to about 500 μm, about 1 μm to about 500 μm, about 10 μm to about 500 μm, about 10 μm to about 400 μm, about 10 μm to about 300 μm, about 10 μm to about 200 μm, about 10 μm to about 100 μm, or about 10 μm to about 50 μm.

In some embodiments, the method of fabricating a supported ceramic membrane comprises:
a) mixing a ceramic powder, a clay powder and a binder to form a mixture;
b) kneading the mixture in step (a) in an aqueous or non-aqueous medium and a humectant to form a ceramic paste;
c) aging the ceramic paste for at least 24 h;
d) extruding the aged ceramic paste in order to form a ceramic green body;
e) coating at least one layer of a ceramic slurry on a surface of the ceramic green body and drying the coated layer of ceramic slurry to form a membrane green body; and
f) at least partially sintering the membrane green body and the ceramic green body at about 1000° C. to about 1500° C. to form the supported ceramic membrane;
wherein the ceramic powder is about 70 wt % to about 80 wt % in the ceramic paste;
wherein the clay powder is about 5 wt % to about 15 wt % in the ceramic paste;
wherein the ceramic powder has an average particle size of about 5 μm to about 20 μm;
wherein the ceramic slurry comprises ceramic powder at about 10 wt % to about 40 wt % relative to the slurry;
wherein the ceramic slurry comprises nitric acid at a concentration of about 0.01 mol/L to about 0.5 mol/L; and
wherein the ceramic slurry further comprises methyl cellulose at about 1 wt % to about 5 wt % relative to the slurry.

The ceramic membrane layer can be a single layered structure. Alternatively, the ceramic membrane layer can be a multilayered structure. The multilayered structure can be formed using one ceramic slurry or a plurality of ceramic slurries. Accordingly, in some embodiments, the step of coating at least one layer of ceramic slurry on a surface of the green body and drying the coated layer of ceramic slurry to form a membrane green body comprises:
i) coating a first layer of a first ceramic slurry on the surface of the green body and drying the coated layer of the first ceramic slurry to form a first membrane green body, the first membrane green body having an exposed surface distal from the surface of the green body; and
ii) coating a second layer of a second ceramic slurry on the exposed surface of the first layer and drying the coated layer of the second ceramic slurry to form a second membrane green body.

In some embodiments, the first ceramic slurry comprises ceramic powder having a particle size of about 1 μm to about 5 μm, or about 1.5 μm to about 5 μm. In other embodiments, the particle size is about 1.5 μm to about 4.5 μm, about 1.5 μm to about 4 μm, about 1.5 μm to about 3.5 μm, about 1.5 μm to about 3 μm, about 1.5 μm to about 2.5 μm, or about 1.5 μm to about 2 μm.

In some embodiments, the second layer of ceramic comprises ceramic powder having a particle size of about 0.05 μm to about 1.5 μm, or about 0.1 μm to about 1.5 μm. In other embodiments, the particle size is about 0.05 μm to about 1 μm, about 0.1 μm to about 1 μm, or about 0.1 μm to about 0.5 μm.

Multiple layers of ceramic slurry can be applied in this way to provide a multilayered ceramic membrane after partial sintering. For example, in a three layered membrane, the first ceramic layer can comprise ceramic powder having a particle size of about 1.5 μm to about 5 μm, the second layer can comprise ceramic powder having a particle size of about 0.5 μm to about 1.5 μm, and the third layer can comprise ceramic powder having a particle size of about 0.1 μm to about 0.5 μm.

The thickness of the multilayered ceramic membrane can be about 1 μm to about 500 μm, about 10 μm to about 500 μm, about 10 μm to about 400 μm, about 10 μm to about 300 μm, about 10 μm to about 200 μm, about 10 μm to about 100 μm, or about 10 μm to about 50 μm.

The present invention also provides a ceramic paste for forming a ceramic support, comprising:
a) a ceramic powder at about 70 wt % to about 80 wt % in the ceramic paste;
b) a clay powder at about 5 wt % to about 15 wt % in the ceramic paste;
c) a binder at about 2 wt % to about 8 wt % in the ceramic paste;
d) a humectant at about 0.1 wt % to about 1.5 wt % in the ceramic paste; and
e) an aqueous medium.

In some embodiments, the ceramic paste comprises:
a) a ceramic powder at about 70 wt % to about 80 wt % in the ceramic paste;
b) a clay powder at about 5 wt % to about 15 wt % in the ceramic paste;
c) a binder at about 2 wt % to about 8 wt % in the ceramic paste;
d) a humectant at about 0.1 wt % to about 1.5 wt % in the ceramic paste; and
e) an aqueous medium;
wherein the ceramic powder has an average particle size of about 5 μm to about 20 μm.

In some embodiments, the ceramic paste has a viscosity of about 1×10+Pa·s to about 5×10+Pa·s at a shear rate of about 10⁻¹ s⁻¹. In other embodiments, the viscosity is about 1×10+Pa·s to about 4×10+Pa·s, about 1×10+Pa·s to about 3×10+Pa·s, or about 1×10+Pa·s to about 2×10+Pa.

In some embodiments, the ceramic paste has a yield flow pressure of about 1000 Pa to about 1500 Pa. In other embodiments, the pressure is about 1000 Pa to about 1400 Pa, about 1000 Pa to about 1300 Pa, about 1000 Pa to about 1200 Pa, or about 1000 Pa to about 1100 Pa.

In some embodiments, the ceramic paste, comprises:
a) alumina at about 70 wt % to about 80 wt % in the ceramic paste;
b) kaolin at about 5 wt % to about 15 wt % in the ceramic paste;
c) carboxymethyl cellulose (CMC) at about 2 wt % to about 8 wt % in the ceramic paste;
d) glycerol at about 0.1 wt % to about 1.5 wt % in the ceramic paste; and
e) an aqueous medium;
wherein the alumina has an average particle size of about 6 μm to about 20 μm.

In some embodiments, the ceramic paste, comprises:
a) alumina at about 75 wt % in the ceramic paste;
b) kaolin at about 8 wt % in the ceramic paste;
c) carboxymethyl cellulose (CMC) at about 4 wt % in the ceramic paste;
d) glycerol at about 0.1 wt % to about 1.5 wt % in the ceramic paste; and
e) an aqueous medium;
wherein the alumina has an average particle size of about 6 μm to about 20 μm.

The present invention also provides a ceramic green body, comprising:
a) a ceramic powder at about 80 wt % to about 90 wt % in the green body;
b) a clay powder at about 5 wt % to about 15 wt % in the green body;
c) a binder at about 2 wt % to about 8 wt % in the green body; and
d) a humectant at about 0.1 wt % to about 1.5 wt % in the green body.

In some embodiments, the ceramic green body comprises:
a) a ceramic powder at about 80 wt % to about 90 wt % in the green body;
b) a clay powder at about 5 wt % to about 15 wt % in the green body;
c) a binder at about 2 wt % to about 8 wt % in the green body; and
d) a humectant at about 0.1 wt % to about 1.5 wt % in the green body;
wherein the ceramic powder has an average particle size of about 5 μm to about 20 μm.

The ceramic green body can be an extruded object. The green body can be dried for at least 24 h. Accordingly, most of the solvent is removed. This aids the handling of the formed structure.

In some embodiments, the ceramic powder is about 80 wt % to about 89 wt %, about 80 wt % to about 88 wt %, about 80 wt % to about 87 wt %, about 80 wt % to about 86 wt %, or about 80 wt % to about 85 wt %.

In some embodiments, the clay powder is about 5 wt % to about 14 wt %, about 5 wt % to about 13 wt %, about 5 wt % to about 12 wt %, about 5 wt % to about 11 wt %, or about 5 wt % to about 10 wt %.

In some embodiments, the binder is about 2 wt % to about 7 wt %, about 2 wt % to about 6 wt %, or about 2 wt % to about 5 wt %.

In other embodiments, the humectant is about 0.1 wt % to about 1.4 wt %, about 0.1 wt % to about 1.3 wt %, about 0.1 wt % to about 1.2 wt %, about 0.1 wt % to about 1.1 wt %, about 0.1 wt % to about 1 wt %, or about 0.1 wt % to about 0.8 wt %.

In some embodiments, the ceramic green body has a total weight loss of about 5 wt % to about 8 wt % at 800° C., under thermogravimetric analysis (TGA). In other embodiments, the weight loss is about 5% to about 9 wt %, about 5% to about 8 wt %, about 5% to about 7 wt %, or about 5% to about 6 wt %.

In some embodiments, the extruded ceramic green body comprises an outer surface and an inner body. In some embodiments, the extruded green body comprises an asymmetric porous structure, where large pores exist in the inner part of the extruded green body. In some embodiments, the extruded green body comprises an inner body conterminous to an outer surface, wherein the inner body comprises a plurality of voids. In this regard, the inner structure and the outer surface shares a common boundary. The voids are formed from air pockets via the extrusion process. The inner body also comprises pores formed from the sintering process of ceramic particles and clay particles.

In some embodiments, the ceramic green body comprises:
a) a ceramic powder at about 80 wt % to about 90 wt % in the green body;
b) a clay powder at about 5 wt % to about 15 wt % in the green body;
c) a binder at about 2 wt % to about 8 wt % in the green body; and
d) a humectant at about 0.1 wt % to about 1.5 wt % in the green body;
wherein the ceramic powder has an average particle size of about 5 μm to about 20 μm; and
wherein the ceramic green body is extruded and comprises an asymmetric porous structure having an inner body conterminous to an outer surface;
wherein the inner body comprises a plurality of voids.

In some embodiments, the ceramic green body comprises:
a) alumina at about 70 wt % to about 80 wt % in the green body;
b) kaolin at about 5 wt % to about 15 wt % in the green body;
c) carboxymethyl cellulose (CMC) at about 2 wt % to about 8 wt % in the green body;
d) glycerol at about 0.1 wt % to about 1.5 wt % in the green body; and
wherein the alumina has an average particle size of about 6 μm to about 20 μm; and
wherein the ceramic green body is extruded and comprises an asymmetric porous structure having an inner body conterminous to an outer surface;
wherein the inner body comprises a plurality of voids.

In some embodiments, the ceramic green body comprises:
a) alumina at about 75 wt % in the green body;
b) kaolin at about 8 wt % in the green body;
c) carboxymethyl cellulose (CMC) at about 4 wt % in the green body;
d) glycerol at about 0.1 wt % to about 1.5 wt % in the green body; and
wherein the alumina has an average particle size of about 6 μm to about 20 μm; and
wherein the ceramic green body is extruded and comprises an asymmetric porous structure having an inner body conterminous to an outer surface;
wherein the inner body comprises a plurality of voids.

The present invention also provides a ceramic support fabricated from a ceramic green body as disclosed herein, comprising:
a) a ceramic at about 85 wt % to about 95 wt % in the ceramic support; and
b) a clay at about 5 wt % to about 15 wt % in the ceramic support.

In some embodiments, the ceramic support comprises:
a) a ceramic at about 85 wt % to about 95 wt % in the ceramic support; and
b) a clay at about 5 wt % to about 15 wt % in the ceramic support;
wherein the ceramic has an average particle size of about 5 μm to about 20 μm.

In some embodiments, the ceramic is about 86 wt % to about 95 wt %, about 87 wt % to about 95 wt %, about 88 wt % to about 95 wt %, about 89 wt % to about 95 wt %, or about 90 wt % to about 95 wt %.

In some embodiments, the clay is about 6 wt % to about 15 wt %, about 7 wt % to about 15 wt %, about 8 wt % to about 15 wt %, about 9 wt % to about 15 wt %, or about 10 wt % to about 15 wt %.

The pore structure of the formed ceramic support can be provided in two ways. Firstly, through the use of the ceramic paste as disclosed herein, an innate porosity is provided via the sintering of the ceramic particles and clay particles. Secondly, larger pores (or voids) within the green body is also formable when the ceramic paste is extruded through a die under pressure. During the extrusion process, the ceramic paste in the pressure head/die would suffer from uneven distributed pressure in the cross-section due to the friction and drag force of the die wall. Correspondingly, the pressure on the ceramic paste would gradually decrease from the wall to the middle. The higher pressure near the wall can thus drive the air migrate to the middle and then aggregate during the extrusion process in the middle portion of the extruded green body and form the larger pores.

In some embodiments, the ceramic support is configured such that the clay is bonded to a surface of the ceramic particle and/or aggregated at the interfaces between the ceramic particles. In some embodiments, the ceramic support has a porosity level of about 30% to about 50%. In other embodiments, the porosity is about 32% to about 50%, about 34% to about 50%, about 36% to about 50%, about 38% to about 50%, about 40% to about 50%, about 42% to about 50%, about 44% to about 50%, or about 46% to about 50%.

In some embodiments, the ceramic support has a pore size distribution of about 0.3 μm to about 3.5 μm. In other embodiments, the pore size distribution is about 0.3 μm to about 3 μm, about 0.3 μm to about 2.5 μm, about 0.3 μm to about 2 μm, about 0.5 μm to about 3 μm, about 0.8 μm to about 3 μm, about 1 μm to about 3 μm, about 1.5 μm to about 3 μm, or about 2 μm to about 3 μm.

In some embodiments, the ceramic support has a multimodal pore size distribution. For example, in some embodiments, the ceramic support has a pore size centered about 1.5 μm. In other embodiments, the ceramic support has a pore size centered about 0.5 μm to about 0.75 μm, about 0.5 μm to about 0.7 μm, or about 0.5 μm to about 0.6 μm.

In some embodiments, when the clay is kaolinite, the clay has a phase composition comprising of mullite, cristobalite, or a combination thereof.

In some embodiments, the ceramic support comprises an asymmetric porous structure, where some large pores exist in the inner part of the ceramic support. In some embodiments, the ceramic support comprises an inner body conterminous to an outer surface, wherein the inner body comprises a plurality of voids. In this regard, the inner structure and the outer surface shares a common boundary. The voids are formed from air pockets via the extrusion process. The inner body also comprises pores formed from the sintering process of ceramic particles and clay particles.

In some embodiments, the void has a diameter of about 0.5 μm to about 100 μm, or about 1 μm to about 100 μm. In other embodiments, the diameter is about 0.5 μm to about 80 μm, about 0.5 μm to about 60 μm, about 0.5 μm to about 50 μm, about 1 μm to about 60 μm, about 1 μm to about 50 μm, about 5 μm to about 50 μm, about 10 μm to about 50 μm, about 20 μm to about 50 μm, about 30 μm to about 50 μm, about 30 μm to about 100 μm, about 40 μm to about 100 μm, about 50 μm to about 100 μm, about 60 μm to about 100 μm, or about 70 μm to about 100 μm.

In some embodiments, there is a homogeneous porous region proximate to or near or at the outer surface. This region can have a thickness of about 40 μm to about 100 μm. In other embodiments, the thickness is about 40 μm to about 100 μm, about 50 μm to about 100 μm, about 40 μm to about 90 μm, about 40 μm to about 80 μm, about 40 μm to about 70 μm, or about 40 μm to about 60 μm. In some embodiments, the outer surface comprises a homogeneous porosity as it only has pores formed from the sintering process of ceramic particles and clay particles.

In some embodiments, the ceramic support comprises:
a) a ceramic at about 85 wt % to about 95 wt % in the ceramic support; and
b) a clay at about 5 wt % to about 15 wt % in the ceramic support;
wherein the ceramic has an average particle size of about 5 μm to about 20 μm; and
wherein the ceramic support comprises an asymmetric porous structure having an inner body conterminous to an outer surface;
wherein the inner body comprises a plurality of voids.

In some embodiments, the ceramic support comprises:
a) a ceramic at about 85 wt % to about 95 wt % in the ceramic support; and
b) a clay at about 5 wt % to about 15 wt % in the ceramic support;
wherein the ceramic support comprises an asymmetric porous structure having an inner body conterminous to an outer surface;
wherein the inner body comprises a plurality of voids;
wherein the voids in the inner body have a diameter of about 1 μm to about 100 μm.

In some embodiments, the ceramic support comprises:
a) a ceramic at about 85 wt % to about 95 wt % in the ceramic support; and
b) a clay at about 5 wt % to about 15 wt % in the ceramic support;
wherein the ceramic support comprises an asymmetric porous structure having an inner body conterminous to an outer surface;
wherein the inner body comprises a plurality of voids;
wherein the voids in the inner body have a diameter of about 1 μm to about 100 μm; and
wherein the ceramic support has a pore size distribution of about 0.3 μm to about 3.5 μm.

In some embodiments, the ceramic support has a pure water permeance of about 6000 L/m²/hr/bar (LMHB) to about 11000 LMHB. In other embodiments, the pure water permeance is about 7000 LMHB to about 11000 LMHB, about 8000 LMHB to about 11000 LMHB, about 9000 LMHB to about 11000 LMHB, or about 10000 LMHB to about 11000 LMHB.

In some embodiments, the ceramic support has a pure water flux at 1 bar of about 7000 LMHB to about 10000 LMHB. In other embodiments, the pure water flux is about 8000 LMHB to about 10000 LMHB, or about 9000 LMHB to about 10000 LMHB.

In some embodiments, the ceramic support has a flexural strength of about 50 MPa to about 250 MPa. In other embodiments, the flexural strength is about 50 MPa to about 250 MPa, about 60 MPa to about 250 MPa, about 70 MPa to about 250 MPa, about 80 MPa to about 250 MPa, about 90 MPa to about 250 MPa, about 100 MPa to about 250 MPa, about 150 MPa to about 250 MPa, or about 200 MPa to about 250 MPa.

In some embodiments, the ceramic support is formed as a multichannel flat-sheet.

In some embodiments, the ceramic support has a mass loss of less than about 5% after being submerged in acid or base for 20 h. In other embodiments, the mass loss is less than about 4%, about 3% or about 2%.

In some embodiments, the flexural strength is maintained after being submerged in acid or base for at least about 10 h, about 15 h or about 20 h.

In some embodiments, the ceramic support is for use in separating oil and water.

The present invention also provides a supported ceramic membrane fabricated from a ceramic green body as disclosed herein, comprising:
a) a ceramic support fabricated from the ceramic green body; and
b) at least one ceramic membrane layer coated on a surface of the ceramic support.

In some embodiments, the ceramic membrane has a thickness of about 3 μm to about 100 μm, about 5 μm to about 100 μm, about 10 μm to about 100 μm, about 20 μm to about 100 μm, about 30 μm to about 100 μm, about 40 μm to about 100 μm, or about 50 μm to about 100 μm. Alternatively, the thickness of the ceramic membrane can be about 1 μm to about 500 μm, about 10 μm to about 500 μm, about 10 μm to about 400 μm, about 10 μm to about 300 μm, about 10 μm to about 200 μm, about 10 μm to about 100 μm, or about 10 μm to about 50 μm.

In some embodiments, at least two ceramic membrane layers are coated on the surface of the ceramic support. Each of the two ceramic membranes is in contact with each other in order to form a multilayered membrane.

In some embodiments, each of the at least two ceramic membrane layers comprises ceramic particles of a different particle size. In other words, each membrane layer comprises ceramic powders having a particle size different from that of the other layer. Thus, for example, in a three layered membrane, the first ceramic layer can comprise ceramic powder having a particle size of about 1.5 μm to about 5 μm, the second layer can comprise ceramic powder having a particle size of about 0.5 μm to about 1.5 μm, and the third layer can comprise ceramic powder having a particle size of about 0.1 μm to about 0.5 μm.

In some embodiments, the supported ceramic membrane comprises:
a) a ceramic support fabricated from the ceramic green body as disclosed herein; and
b) at least one ceramic membrane layer coated on a surface of the ceramic support;
wherein the ceramic membrane layer comprises a ceramic powder at about 10 wt % to about 40 wt %.

In some embodiments, the supported ceramic membrane comprises:
a) a ceramic support fabricated from the ceramic green body as disclosed herein; and
b) at least one ceramic membrane layer coated on a surface of the ceramic support;
wherein the ceramic membrane layer comprises a ceramic powder with a particle size of about 0.05 μm to about 5 μm.

In some embodiments, the supported ceramic membrane comprises:
a) a ceramic support fabricated from the ceramic green body as disclosed herein; and
b) at least one ceramic membrane layer coated on a surface of the ceramic support;
wherein the ceramic membrane layer comprises alumina with a particle size of about 0.1 μm to about 5 μm.

In some embodiments, the ceramic membrane has a pure water flux of about 2000 LMHB to about 4000 LMHB. In other embodiments, the pure water flux is about 2500 LMHB to about 4000 LMHB, or about 3000 LMHB to about 4000 LMHB.

In some embodiments, the ceramic membrane has a retention for 20 nm particles of at least about 50%. In other embodiments, the retention is at least about 55%, about 60%, about 65%, about 70%, or about 80%.

In some embodiments, the ceramic membrane has a retention for 70 nm particles of at least about 80%. In other embodiments, the retention is at least about 85%, about 90%, or about 95%.

### Characterization of Raw Materials

The characteristics of ceramic supports are determined in terms of particle size, distribution, morphology and sintering temperature. Macroporous ceramic supports are generally composed of coarse ceramic particles, the stacking of which helps form the large pores. An increase in particle size will correspondingly enlarge the mean pore size of ceramic supports, which then improve the permeability. However, these larger particles require higher temperature to bond together, and the thus formed supports tend to show rough surface and large surface pores. In this circumstance, there is a need for at least an additional intermediate layer prior to the deposition of top layer in the membrane preparation. This is not desirable.

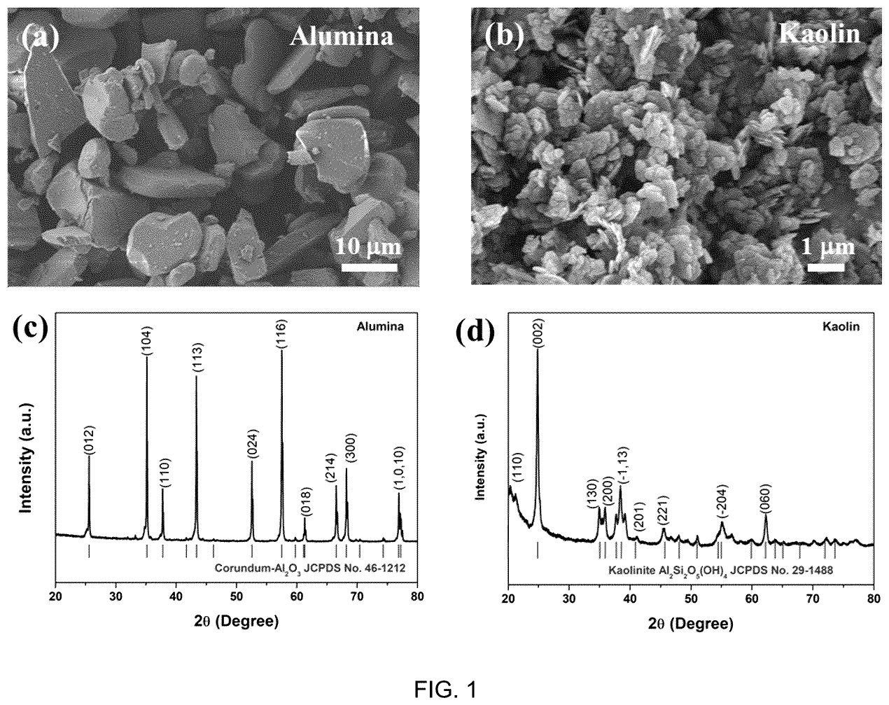

To showcase the present invention, alumina powders with an average particle size of ˜10 μm was selected, and kaolin, a type of low-cost natural clay, was used as the additives to modify the interfaces in the alumina powder matrix. Alumina particles are mostly of an asymmetric plate-like morphology (FIG. 1a), the randomly stacking of which would benefit for the formation of large pores and the improvement of mechanical strength owing to the interlocks. The kaolin powders used in this work are in the form of flakes (FIG. 1b), while their size is much smaller than that of alumina powders. As shown in FIG. 1c-d, the XRD patterns of alumina and kaolin are attributed to corundum alumina (JCPDS No. 46-1212) and kaolinite Al₂Si₂O₅(OH)₄ (JCPDS No. 29-1488), respectively.

### Characterization of Ceramic Paste

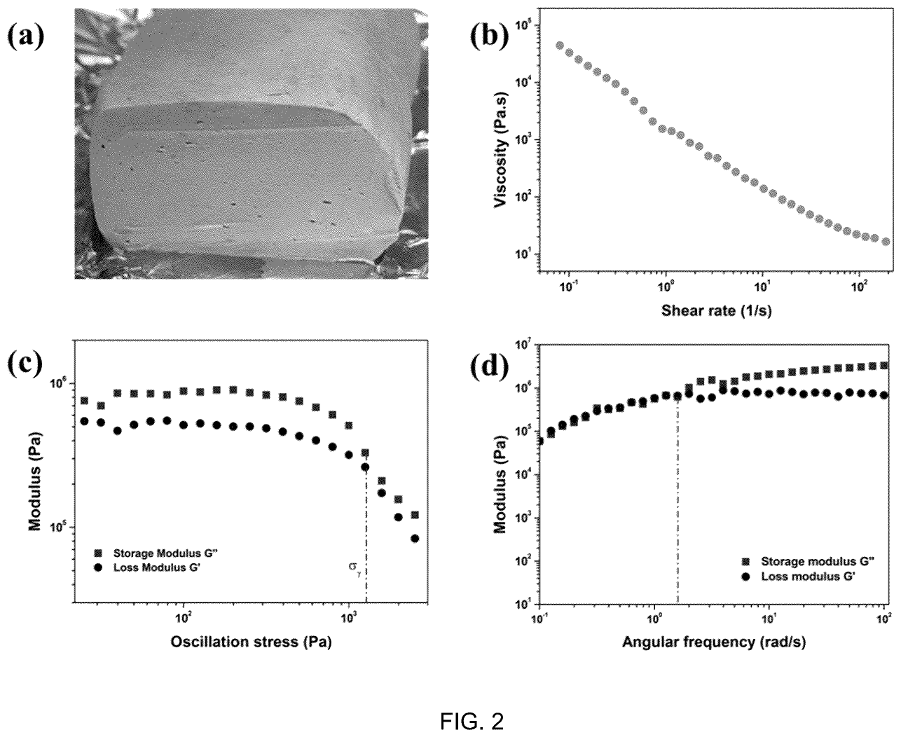

FIG. 2 shows the rheology properties of an exemplary alumina paste, which exhibits shear-thinning behavior with increasing shear. (a) Optical image of the ceramic paste aged for 48 h, showing the fresh cross-section. (b) Apparent viscosity as a function of shear rate. (c) Storage modulus G″ and the loss modulus G′ recorded against the shear stress-amplitude at a constant frequency of 6.283 rad/s. (d) Storage modulus G″ and the loss modulus G′ obtained against the angular frequency.

The as-prepared ceramic paste show good formability, and some pores are observed from the fresh cross-section (FIG. 2a), which is mostly formed due to the introduction of air during the kneading process in atmospheric condition. Furthermore, the rheological property of the ceramic paste was systematically examined. As shown in FIG. 2b, the ceramic paste exhibits shear thinning behavior, which is necessary for a smooth extrusion process. The viscosity of the ceramic paste is relatively high at low shear rates (e.g., . . . 2×10⁴ Pa·s @10⁻¹ s⁻¹), which is required for the ceramic paste to have a self-standing rigid behaviour after extrusion. With the increase in shear rate, the viscosity drops rapidly, which enables and is necessary for the ceramic paste flow through the pressure die under the applied pressure. When oscillatory stress amplitude sweep tests were conducted, the storage modulus G′ obtained is consistently higher than that of the loss modulus G″, indicating a highly self-standing and elastic behaviour of the ceramic paste. However, storage modulus G′ and loss modulus G″ values tend towards each other near σ_{y}=1200 Pa, suggesting a slight yielding of the materials; this indicates the pressure where the ceramic paste would start to yield-flow (FIG. 2c). Therefore, the ceramic paste will intermediately retain its shape once the imposed shear falls below σ_{y}. As monitored during the extrusion process, the applied pressure (˜28 bar) is much higher than σ_{y}, allowing the ceramic paste to be extruded through the pressure die. The storage modulus G′ is also seen to gradually increase with the oscillatory frequency (FIG. 2d). At low angular frequency, the loss modulus G″ equals to the storage modulus G′, while the loss modulus G″ is angular 5 frequency independent above a certain value. This further suggests that the ceramic paste exhibits an clastic solid behaviour, where the connection between the ceramic particles (e.g., van der Waals and hydrogen bonds) are strong enough to hold the entire network together and form a self-standing structure.

### Characterization of Extruded Ceramic Green Body

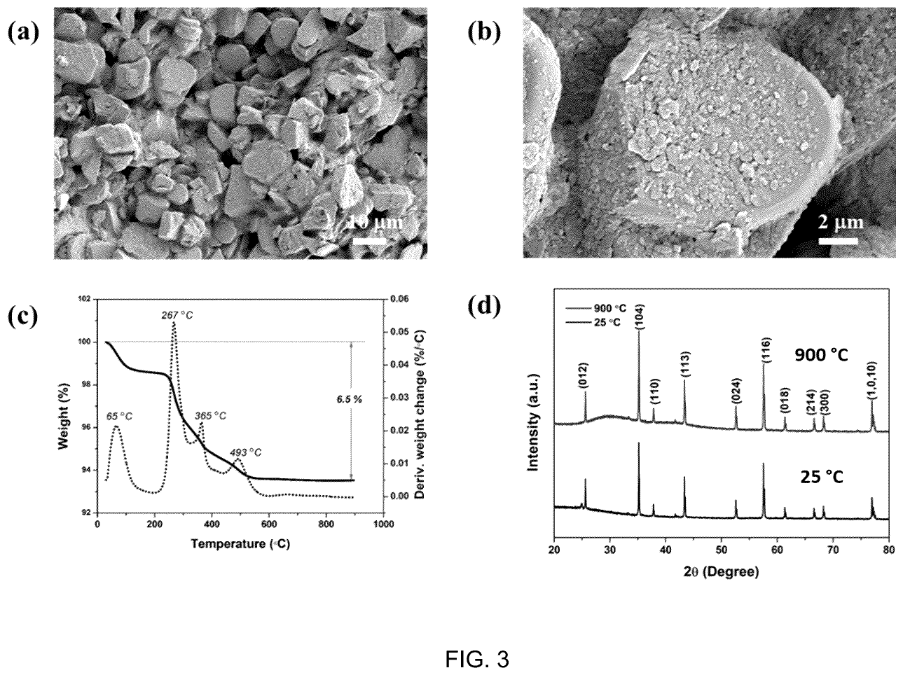

FIG. 3 shows (a-b) surface SEM images. (c) TGA curve, and (d) XRD patterns before and after thermal treatment, of the extruded green body of ceramic support after drying at room temperature for 48 h. The insert in the TGA curve shows the percentage of each component.

These features of the ceramic paste enabled a smooth and continuous extrusion process. As observed in SEM images of the extruded ceramic green body (FIG. 3b), kaolin nanoflakes randomly decorated on the surface of coarse alumina particles. This led to changes in the interfaces among these alumina particles, and thereby their sintering behaviour.

Prior to the sintering at high temperature, the thermal behaviour of the extruded samples was analyzed by TGA. With the increase in temperature, the residual water and organic additives will be burn off gradually. As shown in FIG. 3a, the extruded green body mainly was composed of the coarse alumina particles, and the kaolin nanoflakes were uniformly decorated on the surface of coarse alumina particles (FIG. 3b). With the increase in temperature, the residual water and organic additives is being burnt off gradually. As shown in FIG. 3c, those notable weight drops observed at 65° C. 267° C. and 365° C. are attributed to the evaporation of water, and the pyrolysis of CMC and glycerol, respectively. The minor weight loss at 493° C. is due to the dehydroxylation of kaolinite (Al₂O₃·2SiO₂·2H₂O→Al₂O₃·2SiO₂). This was also confirmed by the TGA results of kaolinite. The weight of green body was steady at 800° C. and the total weight loss was about 6.5 wt %. According to the components in the ceramic paste, the weigh percentage of organic additives (i.e., . . . glycerol and CMC) is about 5.1 wt %. Given the additional water molecules in the green body, the actual weight loss can thus be well interpreted, suggesting the good homogeneity of the ceramic paste.

The addition of the minor amount of kaolin into the alumina matrix did not change the phase composition, and the XRD patterns (FIG. 3b) remains the corundum alumina (JCPDS No. 46-1212). With the temperature being increased to 900° C. a broad peak was observed at around 20-30°, which was correlated to the existence of amorphous silicate state derived from kaolin.

### Macroscopic Properties of Ceramic Supports

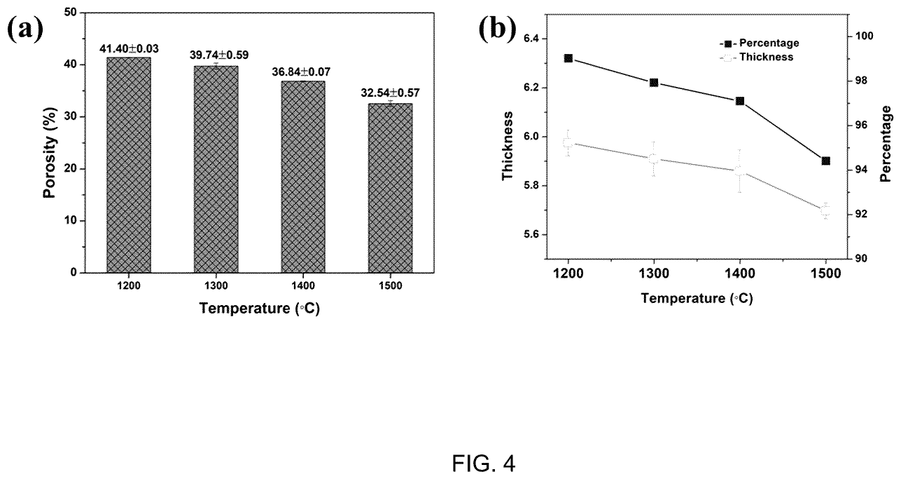

The level of open porosity in a porous ceramic supports is among the crucial factors for water permeability. For the ceramic support with a specific component, the level of open porosity is closely related to the sintering temperature. With an increase in sintering temperature from 1200° C. to 1400° C. the level of open porosity of the ceramic support decreased gradually from 41.40±0.03% to 36.84±0.07% (FIG. 4a). However, a relatively large decrease to 32.54±0.57% was observed when the temperature was increased to 1500° C. Compared with the ceramic supports reported in previous work, the level of open porosity of the ceramic supports herein is relatively low, as the extruded supports generally show a lower level of porosity and smaller pore sizes than those in pressed supports, mainly due to the higher pressure and longer loading time during extrusion process. The actual pressure in pressure head was detected to be about 28 bar, which is much higher than that of a unidirectional press process.

According to the change in thickness of the ceramic supports before and after sintering, the shrinkage as a function of the firing temperature was determined (FIG. 4b). Overall, the thickness gradually decreased with the firing temperature, thereby the shrinkage was increased. The phenomena is widely observed in ceramic sintering process. When the firing temperature was increased from 1200° C. to 1400° C. the shrinkage increases slightly and almost linearly (−0.0096%/° C. R²=0.9969). However, the shrinkage was increased notably at 1500° C. with a value of −0.0269%/° C. Such a notable increment in thickness suggests the improved densification.

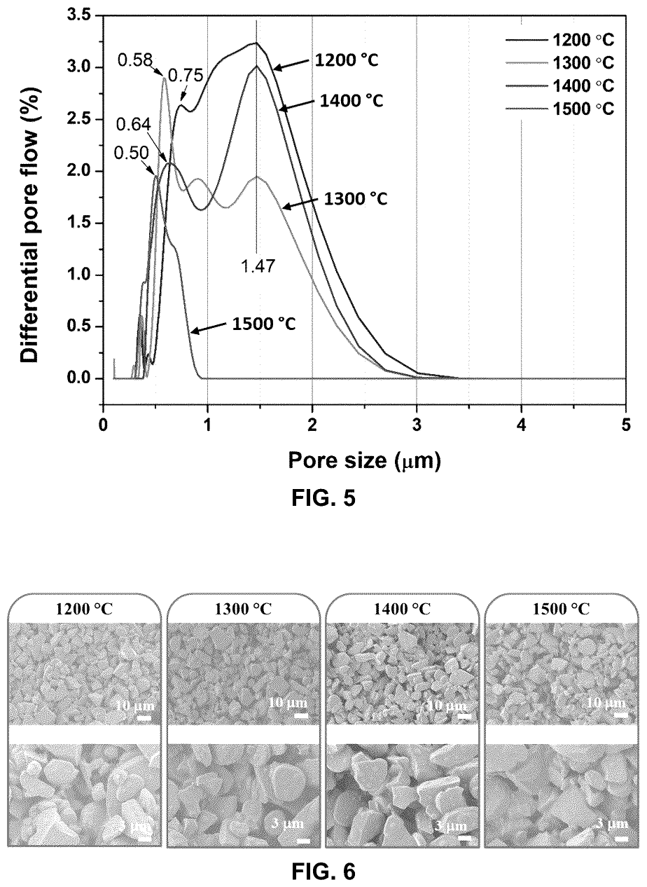

As a membrane support in the filtration process, the ceramic support serves as a barrier for water, and the water permeability is largely dependent on the population and the volume of through-pores. The overall pore size distribution across the thickness direction of the porous support was further evaluated by using a capillary flow porometer (CFP), which had been widely used to assess the pore size distribution of the membrane layer. As shown by the results plotted in FIG. 5, the ceramic supports prepared at 1200-1400° C., show a broad pore size distribution from 0.3 μm to 3.5 μm, while the largest pores of the ceramic support prepared at 1500° C. is reduced to about 1 μm. The results agree with the changes in the level of open porosity and shrinkage (FIG. 4). A further look into the pore size distribution of ceramic supports prepared at 1200-1400° C. reveals the multimodality, and all of them have a peak centered at 1.47 μm. A small shoulder centered at 0.75 μm is observed for the ceramic support sintered at 1200° C. For the sample sintered at 1300° C. the main peak of pore size distribution shifts leftward to 0.58 μm, along with another peak at 1 μm (medium pore), while the main peak of the ceramic support prepared at 1400° C. is centered at 1.47 μm.

### Microstructural Characteristics of Ceramic Supports

To understand the changes in the level of porosity, shrinkage and pore size distribution, the microstructure of ceramic supports was examined. FIG. 6 shows the surface SEM images of the porous ceramic supports sintered at different temperatures. From the low magnified view (top), all the ceramic supports present a porous microstructure, suggesting the partial sintering feature, which is required for high permeable ceramic supports. With a close look into the enlarged view (bottom), it can be found that the ceramic particles retained the main morphology of the original alumina particles, while the smaller kaolin nanoflakes can hardly be observed. With the increase of firing temperature from 1200° C. to 1400° C. the pores between the coarse alumina particles are enlarged. This observation can be correlated to the existence of kaolin nanoflakes. Kaolin is a natural clay with low melting point. At room temperature, small sized kaolin particles are uniformly distributed in the coarse alumina matrix (FIG. 3b). With the increase in temperature, kaolin would undergo dehydration and several phase transitions. Silica as a precipitated liquid phase would slowly migrate toward the connection points between coarse alumina particles, and then joined together. When the temperature is above the melting point, kaolin will melt, and slowly migrate towards the connection points between coarse alumina particles, and then joint together. This process will proceed with the increase of sintering temperature. In other words, most of the kaolin will locate at the narrow necks between the coarse alumina particles, and the big space between alumina particles will be released gradually, resulting in the appearance of larger pores at higher temperature. However, when the temperature was further increased to 1500° C. the surface microstructure become sintered, where the pores between the coarse particles gets narrowed (˜0.5 μm). This microstructural evolution can evidently support the observed changes in the level of open porosity, sintering shrinkage, and pore size distribution in the ceramic support.

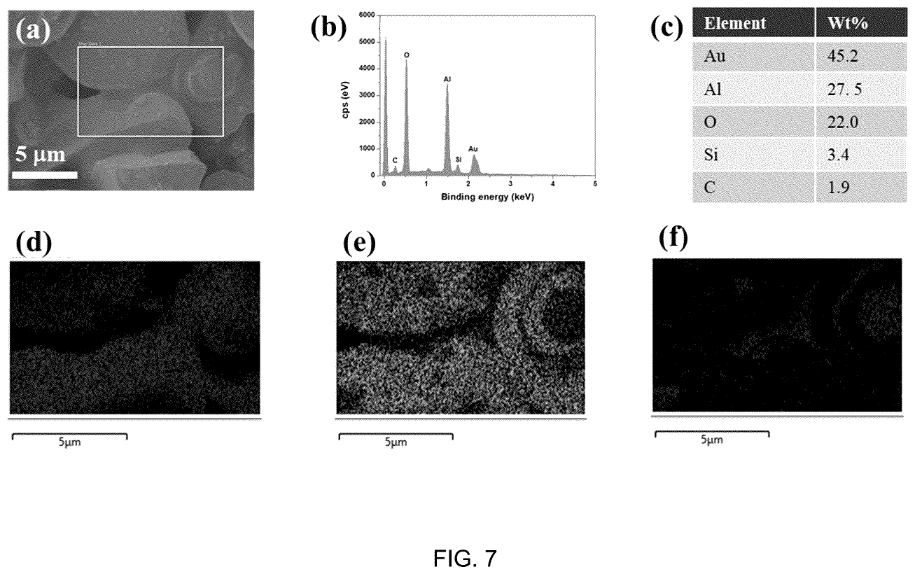

FIG. 7 shows compositional analysis of the ceramic support prepared at 1400° C. (a) SEM image, where the white rectangle area is the selected for characterization. (b) EDS spectra. (c) Quantitative results of each element, and elemental distribution of (c) O, (d) Al and (c) Si.

The liquid sintering feature was observed in all the samples (FIG. 6), as the calcination temperatures are much higher than the melting point of kaolin. There are a lot of drop-like humps on the coarse particles, which provide evidences for the formation of liquid phase at high temperature. Besides, there are thickened necks between the coarse particles. Both the humps and necks should be derived from kaolin. A position with three coarse particles connected was selected for elemental analysis (FIG. 7a). As shown in FIG. 7b, the main elements detected include O, Al, Si, C and Au. The considerable level of Au element come from the deposition of electrode, and the trace C is from the free carbon in the surroundings. Therefore, the ceramic supports are composed of O (22.0 wt %). Al (27.5 wt %) and Si (3.4 wt %). The elemental distribution in FIGS. 7d-f show that the coarse particles are composed of Al and O, while the necks and humps contain Si. The results evidently demonstrate the significant role of kaolin in the liquid-phase sintering.

The observed evolution of pore size distribution as a function of increasing sintering temperature (FIG. 5) can be understood, based on the distribution/location of kaolin and coarse alumina particles. In the sintering temperature range (1200-1400° C.), the additive kaolin was melted and resulted in the formation of silica, which then contributed to the liquid sintering at high temperature. Due to the difference in holding temperature and the time experienced above the melting point, the liquid phase could locate differently and kaolin derived substances are accumulated differently.

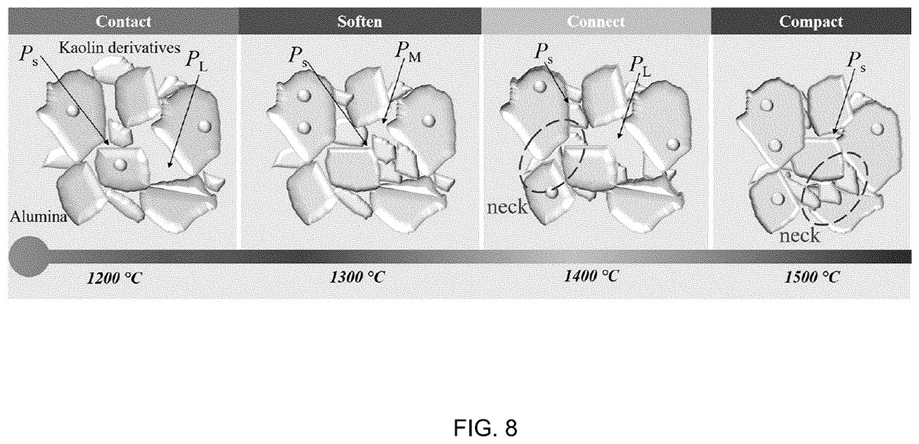

FIG. 8 is a schematic illustration of the microstructure evolution of kaolin-alumina ceramic supports with the increasing of calcination temperature. (a) Alumina particles and kaolin particles stacked randomly with the smaller kaolin particles occupying some of the interspace between coarse alumina particles. (b) Kaolin particles start to molten, which tend to aggregate at the big gaps between alumina particles. (c) Kaolin particles joined together and formed the necks between alumina particles. (d) Coarse alumina particles start to compact together.

As illustrated in FIG. 8, the larger pores (P_{L}) are mainly originated from the stacking of coarse alumina particles, and the smaller pores are generated by the kaolin additive and their derivatives. When the sintering temperature was below 1500° C. only a slightly overall shrinkage was observed, and the spacing between coarse alumina particles did not change significantly. This explains the appearance of identical large pores (˜1.47 μm) in ceramic supports prepared at 1200° C. 1300° C. and 1400° C. At 1200° C. these small kaolin nanoflakes are still randomly distributed in the coarse alumina matrix, and all the particles just contact with the neighbours (FIG. 8a). This results in a dispersive and broad pore size distribution. As the temperature was increased to 1300° C. the molten kaolin has experienced a longer time at high temperature and soften, which would migrate on surface of coarse alumina particles. As a result, some of kaolin would hang on the walls of larger pores (P_{L}), thereby forming the medium pores (P_{M}), as shown in FIG. 8b. Since the formation of medium pores (P_{M}) are at the expense of larger pores (P_{L}), their ratios will both be reduced and the smaller pores (P_{S}) thus become the dominant. When the ceramic supports are sintered at 1400° C. there are sufficient time for the migration of the molten kaolin, it would accumulate between the coarse alumina particles and thicken the interfacial necks (FIG. 8c). In this way, the larger pores (P_{L}) between coarse alumina particles are released and become the dominant. This also explains the phenomena that the necks mainly composed of Si are observed above 1300° C. With the increase in firing temperature, the pore evolution process mainly involves the gradually reduced amount of smaller pores (P_{S}) and the increased number of larger pores (P_{L}). However, at 1500° C., coarse alumina particles start to tighten together (FIG. 8d), resulting in the disappearance of larger pores (P_{L}) and the notable shrinkage.

### Permeability of Ceramic Supports

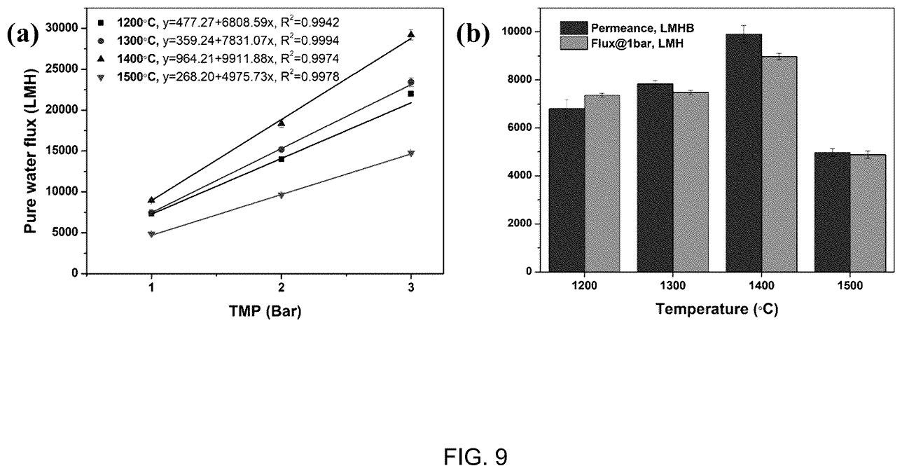

FIG. 9 shows water permeability of the ceramic supports prepared at different temperatures. (a) Pure water flux measured at various TMPs (1, 2 and 3 bar) and (b) Pure water flux measured at a TMP of 1 bar and the pure water permeance.

The water flux of the ceramic supports was measured at various TMPs to evaluate their water permeability. As shown in FIG. 9a, the water flux of the ceramic supports fired at various temperatures increase linearly with the TMP, as indicated by the high R² values (>0.99). The pure water flux at the TMP of 1 bar and the water permeance are plotted in FIG. 5b. With the increase in sintering temperature from 1200° C. to 1400° C., both water flux and permeance increased gradually.

The water permeance of a ceramic support increases with the level of open porosity, vice versa. However, in this work, the increase in permeance of the ceramic supports prepared at 1200-1400° C. are mainly attributed to the gradually increased proportion of large pores. This suggests that in addition to the open porosity, both pore structure and pore size distribution greatly affect the permeation of ceramic supports. However, with the further increase in sintering temperature to 1500° C., both water flux and permeance dramatically dropped. This originates from the notable densification of coarse alumina particles and the greatly sintered microstructure.

TABLE 1
Summary of the pure water flux at 1 bar and the pure water permeance
of ceramic supports prepared at different temperatures.

| | Permeance/ | STEV/ | Flux@1 bar/ | STEV/ |
|---|---|---|---|---|
| T/° C. | LMHB | LMHB | LMH | LMH |
| 1200 | 6808.585 | 368.3093 | 7361.96 | 79.48749 |
| 1300 | 7831.074 | 137.6716 | 7479.48 | 86.93064 |
| 1400 | 9911.881 | 357.509 | 8969.52 | 138.0883 |
| 1500 | 4975.73 | 164.2323 | 4882.7 | 156.1396 |

The water permeability of ceramics supports prepared is much higher than those reported in previous works (Table 2). Especially, the ceramic supports prepared at 1400° C., showed a pure water flux of 8969±138 LMH at 1 bar and a permeance of 9912±357 LMHB.

TABLE 2
Comparison of properties of ceramic supports with an embodiment of the present
invention (last row)

| | | | | Pore | | Permeance/ |
|---|---|---|---|---|---|---|
| Phase | Raw materials | T/° C. | Porosity/% | size/μm | Strength/MPa | LMHB |
| Magnesium | Bauxite, | 1300 | — | 4.42 | 35.6 | — |
| aluminate | Magnesite | | | | | |
| spinel | | | | | | |
| — | Kaolin, Dolomite | 1250 | 43 | 28 | 16 | — |
| Mullite | Kaolin, Al(OH)₃, | 1300-1550 | 27-55.6 | 0.73-1.5 | 15.5-66.7 | — |
| | AlF₃ | | | | | |
| — | Kaolin, aluminum | 1250 | 28.5 | 0.95-2.0 | 10-16 | — |
| — | Kaolin | 900 | 37 | 0.3-0.8 | 48 | 78-1027 |
| Zeolite | Natural zeolite | 900 | 43.7 | 0.55 | 12.65 | — |
| Mullite, | Kaolin, CaCO₃ | 1250 | 49 | 3 | 87 (alumina) | — |
| Anorthite | | | | | | |
| | Kaolin et al. | 850-950 | 18.88-5.59 | 1.59-2.56 | — | — |
| — | α-alumina, Kaolin | 1450-1525 | 3-18.7 | 0.18-0.328 | 98-174 | — |
| — | α-alumina, TiO₂ | 1650 | 38 | 8.0 | 55.4 | — |
| — | α-alumina, Kaolin | 1450 | 44 | 1.3 | — | 540 |
| Mullite | α-Al₂O₃, Calcined | 1500 | 45 | 0.3~5 | — | — |
| | carbonaceous | | | | | |
| | Kaolin | | | | | |
| — | Alumina, Kaolin | 1200 | >36 | 0.7 | 39 | 1587.31 |
| Mullite | α-Al₂O₃, Kaolin, | 1500 | 45.9 | 1.3 | — | — |
| | Al(OH)₃, AlF₃ | | | | | |
| — | Alumina, Clay | 1350 | 48 | 0.75 | 37 | 850 |
| — | α-alumina | 1500 | 35-54 | — | 17.7-57.4 | — |
| — | α-alumina, TiO₂ | 1650 | 30.01 | 4.3 | 77.33 | ~8250 |
| — | Alumina, kaolin | 1150 | 41 | 0.59 | 15.7 | — |
| | and natural zeolite | | | | | |
| — | α-alumina, | 1550 | 49.5 | 3.1 | 47-54 | — |
| | colloidal silica | | | | | |
| Alumina | — | — | — | 1 | >40 | 3240-3250 |
| Alumina | α-alumina, Kaolin | 1400 | 36.84 | 1.47 | 109.6 | 9911 |

Alumina (Al₂O₃);
Cordierite (2MgO•2Al₂O₃•5SiO₂);
Kaolin (Al₂O₃•2SiO₂•2H₂O);
Mullite (3Al₂O₃•2SiO₂);
Dolomite (CaMg(CO₃)₂);
Anorthite (CaO•Al₂O₃•2SiO₂);
Magnesium aluminate spinel (MgAl₂O₄);
Coalgangue; Kyanite;
Marketed supports are generally manufactured from compounds, such as alumina (Al₂O₃), cordierite (2MgO•2Al₂O₃•5SiO₂) and mullite (3Al₂O₃•2SiO₂).

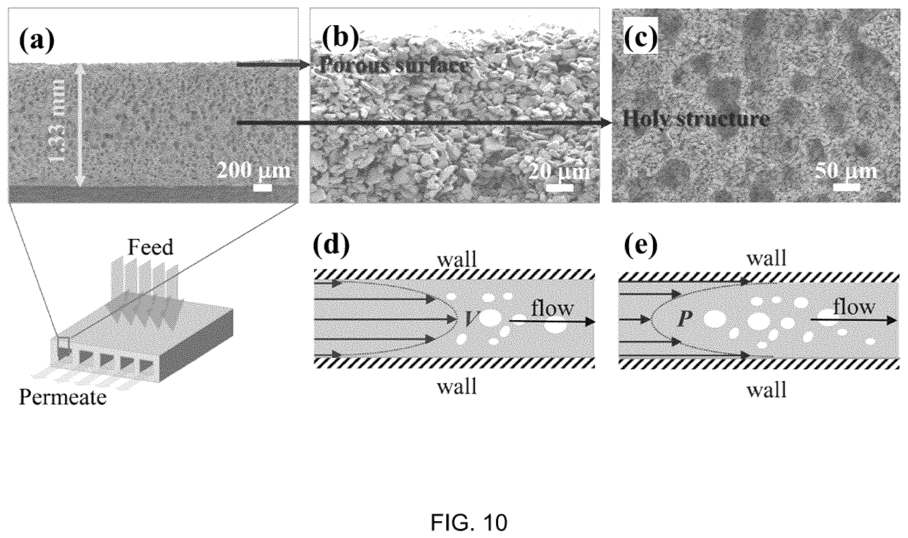

The overall microstructure of the ceramic supports was further examined. FIG. 10a shows the cross-sectional SEM image of the flat-sheet ceramic support, from which an asymmetric porous structure is observed in the framework. The porous structure near the surface and channel walls are constructed by the partially sintered coarse alumina particles (FIG. 10b), while additional large pores are observed in the middle region (FIG. 10c). These large pores in the ceramic support can well contribute to the open porosity and reduce the water resistance, thereby improving the water permeability. Therefore, the much-improved water permeance of these ceramic supports are attributed to the thin barrier layer (1.33 mm) and inner porous microstructure.

Pore-forming agents were widely used to generate these large pores in ceramic supports, and their uniform distribution in the ceramic matrix results in the symmetric porous structure. On the contrary, the formation of these large pores in the present invention is correlated to the preparation process. As the mixing/kneading process of the ceramic paste is conducted in atmospheric condition, air could be introduced into the ceramic paste, as evidenced in FIG. 2a. During the extrusion process, the ceramic paste in the pressure head/die would suffer from uneven distributed pressure in the cross-section. As illustrated in FIG. 10d, the velocity of the ceramic paste near the wall of the pressure head/die is slightly lower than that of the middle part, due to the friction and drag force of the wall. Correspondingly, the pressure on the ceramic paste would gradually decrease from the wall to the middle (FIG. 10e). The higher pressure near the wall can thus drive the air migrate to the middle and then aggregate during the slow extrusion process. As a result, the air bubbles will aggregate in the middle part and form the large pores. Therefore, the formation of asymmetrically distributed large pores in the ceramic support is attributed to the directed migration of air bubbles during the high-pressure extrusion process. The unique asymmetric microstructure with a relatively tightened and homogeneous surface will benefit for the deposition of fine top-layer and avoid the undesirable penetration. To our best known, this is the first report about such an asymmetric porous ceramic support, which would greatly promote the development of highly permeable ceramic membranes. 39

### Flexural Strength

In addition to the permeability, mechanical strength of the ceramic support is another crucial consideration for their application. For example, some ultrathin and much porous ceramic supports certainly exhibit high permeability, while their poor mechanical strength would in turn hamper their application. Due to the asymmetric configuration of the multichannel flat-sheet ceramic support, flexural strength at different directions has been considered.

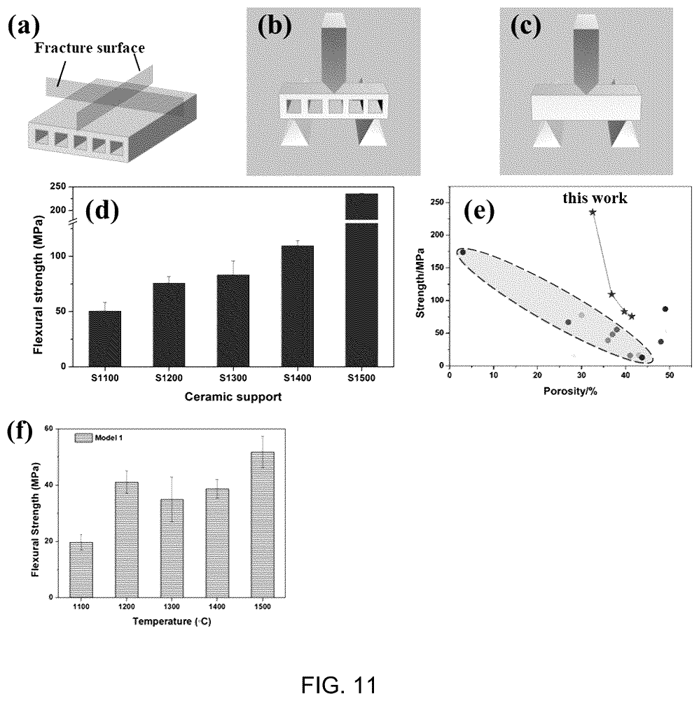

FIG. 11 shows flexural strength of the ceramic support prepared at 1400° C. (a) Illustration of the asymmetric structure of the flat-sheet ceramic support, and the flexural strength in different models: (b) Model 1, with the fracture surface along the channels, and (c) Model 2, with the fracture surface perpendicular to the channels. (d) Flexural strength measured with the fracture surface perpendicular to the channels, where C1 and C2 are two commercial ceramic supports with the same configuration. (e) Porosity dependent mechanical strength compared with the values of previous work in Table 2. (f) Model 1, with the fracture surface along the channels.

As illustrated in FIG. 11a, the flexural strength of fracture surface parallel to the channels should be much weaker than that perpendicular to the channels. Given the working condition of the multichannel flat-sheet ceramic membranes, for example in membrane bioreactors (MBRs), where both ends of the open channels will be sealed by a pair of holders, the mechanical fracture strength in perpendicular to the channels is thus mainly considered. Three-point flexural strength method was adopted to measure the flexural strength of the ceramic supports, and both fracture surfaces parallel and perpendicular to the channels were examined, as illustrated in FIG. 11b and FIG. 11c, respectively. FIG. 11d shows the mechanical strength of the fracture surface perpendicular to the channels, which is the main consideration in submerged membrane bioreactors. With the increase in sintering temperature from 1100° C. to 1400° C. the flexural strength of the ceramic supports gradually increases from 50 MPa to 110 MPa. According to the evolution of microstructure, the increase of flexural strength is mainly related to the increased interface area and therefore strong intergrain bond, and the slightly reduced porosity. It is generally believed that the mechanical strength of the ceramic supports is exponentially related to the porosity. When the sintering temperature further increased to 1500° C. the flexural strength jumped to ˜235 MPa. Such a huge rise is attributed to the much compact microstructure of the coarse alumina matrix. A similar trend was also observed in the flexural strength measured with fracture surface parallel to the channels. Significantly, the ceramic support with the highest permeability also showed a high flexural strength (˜110 MPa). Both flexural strengths of ceramic supports prepared at 1200° C. are above those of commercial products (flexural strength is about 20˜60 MPa) (FIG. 11d), which are however sintered at above 1400° C. When the sintering temperature was further lowered to 1100° C. (FIG. 11d), the samples showed a flexural strength of 50 MPa, which was comparable to that of those commonly reported. Given that the apparent mechanical strength of ceramic membrane supports is a key consideration in the application regardless of the configuration, a comparison of the flexural strength of ceramic supports with those previously reported is shown in Table 2. Also, the mechanical strength of ceramic supports in this work are much higher than most of the comparator ceramic supports (Table 2), especially as compared to those with the comparable or lower levels of porosity. The mechanical strength as a function of porosity is plotted in FIG. 11e. The mechanical strength of the ceramic supports are significantly improved compared to those with comparable or lower level of porosity. Therefore, the addition of low-cost kaolin with low melting point is demonstrated as an effective way to prepare the high-permeable and high-strength alumina-based supports at reduced temperature by means of the rational engineering of the interface and multi-level porous structure.

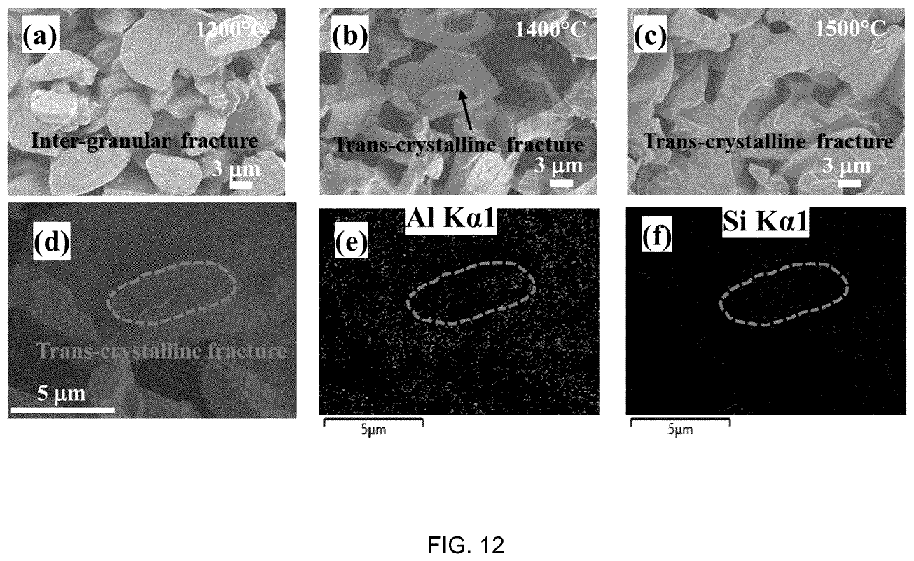

FIG. 12 shows microstructure and elemental distribution of fracture surface. Cross-sectional SEM images of ceramic supports fired at: (a) 1200° C. (b) 1400° C. and (c) 1500° C. (d) Enlarged view of (b), and the distribution of element: (c) Al and (f) Si.

To understand the mechanism of the much enhanced flexural strength. SEM images of fracture surface of the ceramic supports are presented in FIG. 12. The grains are well-integrated in the samples prepared at 1200° C. (FIG. 12a), suggesting the inter-granular fracture behaviour. In addition, there are a plenty of small droplet-like grains bonded on the coarse grains, which are also well-integrated and smooth. For the samples sintered at 1400° C. (FIG. 12b), the drop-like grains disappear and only coarse particles are observed. Notably, some broken grains are observed, which are well-bonded on the coarse grains, indicating the trans-crystalline fracture behaviour. Such trans-granular fractures are also seen in the samples prepared at 1500° C. (FIG. 12c). The overall microstructure become denser and the interface area are increased largely, which accounts for the huge rise in flexural strength.

According to the elemental analysis results shown in FIG. 7, it can be inferred that the smaller droplet-like grains and the trans-granular fractured grains on the coarse grains are the kaolin-derived products, and the coarse grains are of alumina. To further confirm, the distributions of Al and Si elements on the fracture surface are shown in FIG. 12. As highlighted by the yellow circle, the broken grains are abundant in Si element yet insufficient in Al element. Moreover, the disappearance of small droplet-like grains on the coarse grains further evidences the microstructure evolution mechanism in FIG. 8; namely, the kaolin-derived molten droplets at high temperature gradually migrate to the necks of these solid alumina grains and aggregate to increase the interface area. Besides, the broken necks indicate that the interfacial bonding of the necks and alumina grains is stronger than that of the neck itself. Kaolin alone after calcination at 1400° C. would transformed to mullite and cristobalite. When incorporated in alumina matrix, excess SiO₂ in kaolin can be consumed on the surface of coarse alumina particles. Therefore, it is believed that there forms mullite at the interface between the necks and coarse alumina, while the thickened necks are mainly composed of cristobalite with an abundant amount of Si element, which becomes the fracture surface.

### Chemical Resistance

The chemical resistance of the ceramic supports was examined by soaking them in aqueous solutions of NaOH (10 wt %) and H₂SO₄ (20 wt %) for 20 h. To avoid the residual of free particles and chemicals, the corroded ceramic supports were thoroughly cleaned in DI water using ultrasonic treatment until the pH values of the solution become stable and near neutral. After further drying at 120° C. overnight, the changes in mass, level of open porosity, flexural strength and microstructure were considered.

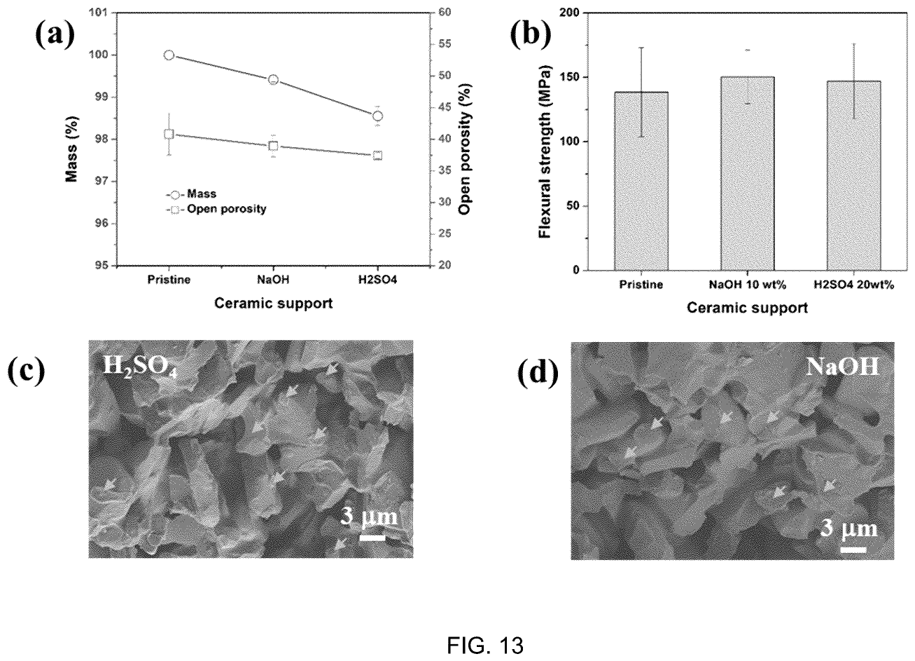

FIG. 13 shows physical properties and fracture microstructure of ceramic supports after corroded in NaOH (10 wt %) and H₂SO₄ (20 wt %) aqueous solution for 20 h. (a) Mass and open porosity. (b) Flexural strength, and (c, d) SEM image of the fractural surface.

As shown in FIG. 13a, the mass loss of ceramic supports corroded in H₂SO₄ solution is slightly higher than that in NaOH solution, while both are less than 2 wt %. Given the overall duration of 90 min with the ultrasonic treatment, the minimized mass loss also suggests the good mechanical stability of the ceramic supports. Due to the minimized mass loss, the level of open porosity of the corroded supports did not show obvious changes, but become more uniform especially for the ones corroded in H₂SO₄ solution, as evidenced by the narrowed error bars. These supports tested in NaOH (10 wt %) and H₂SO₄ (20 wt %) maintain a flexural strength comparable to the pristine supports (FIG. 13b). The fracture surfaces of the supports corroded in NaOH (10 wt %) and H₂SO₄ (20 wt %) both remain the trans-crystalline fracture feature, as indicated by the lacerated grains in FIGS. 13c-d. The surface microstructure and chemical composition of the samples after corrosion treatment are also examined. Both the samples in H₂SO₄ 20 wt % and NaOH 10 wt % retain similar surface features to that of the pristine. Compositional analysis results show that the Si content in the samples treated in NaOH 10 wt % was slightly reduced, suggesting that weak corrosion occurs on the surface, as evidenced by the rings and holes surrounding the drop-like humps. However, the drop-like humps are still abundant in Si element. The results suggest that the ceramic supports show excellent acid- and alkali-resistance, which can endure the generally chemical washing during the water and wastewater treatment.

### Filtration Performance

Oily wastewater has drawn increasing attention because of the extensive oilfield development and the oil-spill incidents. Due to the intrinsic hydrophilic characteristic, macro-porous ceramic membrane supports can be directly adopted to remove the oil phase in oily wastewater. The ceramic membrane supports prepared at 1400° C. were used to treat the synthetic oily wastewater with different concentrations.

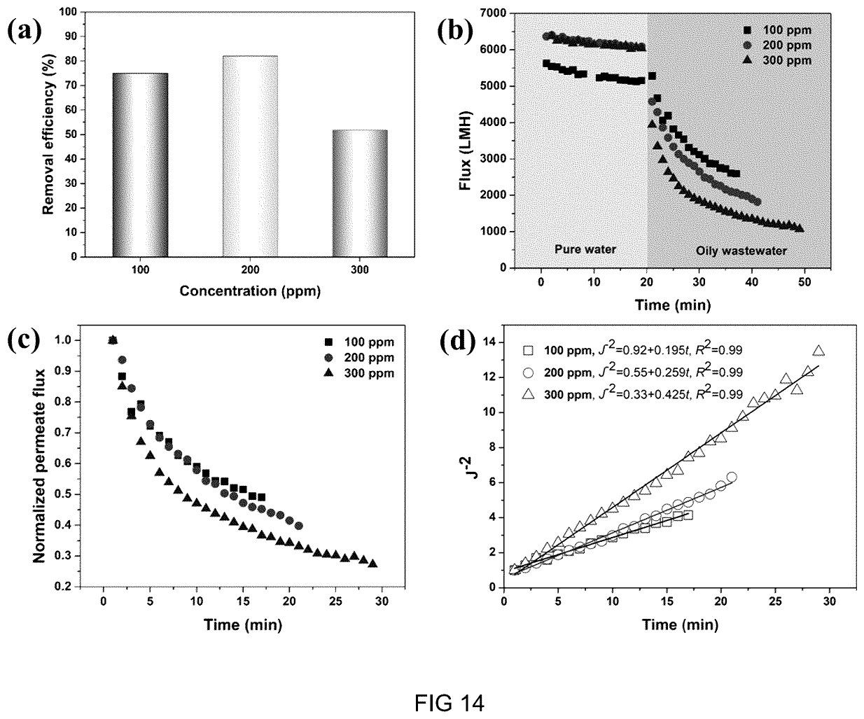

FIG. 14 shows filtration performance and fouling mechanism of the ceramic membrane supports in oily wastewater treatment. (a) Removal efficiency. (b) flux as a function of time for pure water and oily wastewater. (c) Normalized permeate flux as a function of time for oily wastewater, and (d) Plots of the fitting results based on the cake filtration model.

As plotted in FIG. 14a, the removal efficiency was 75%, 80% and 50% for the oily wastewater of 100 ppm. 200 ppm and 300 ppm, respectively. The initial permeate flux decreased with the increase in oil concentration (FIG. 14b). With the increase in filtration time, the permeate flux decreased rapidly mainly because of the concentration polarization and the adsorption of oil droplets on the surface of the ceramic support. After 10 min, the flux decline was obviously slowed down.

To understand the fouling mechanism, the normalized flux decline was plotted in FIG. 14c and four classical models were used to analyze the fouling process (FIG. 14d). For the oily wastewater with low concentrations (100 ppm and 200 ppm), their normalized flux declines are the same in the first 10 min. suggesting the similar fouling rate, while the one with higher concentration (200 ppm) decreased more quickly after 10 min, and the normalized flux of high concentrated oily wastewater (300 ppm) was the lowest over the whole filtration process. As presented in FIG. 14d, the fouling phenomena of the ceramic supports in the oily wastewater were dominated by the cake layer, suggesting that the oil droplets were largely deposited on the surface of the membrane support. Previously, it was found that the fouling model of the ceramic supports was dominated by the standard blocking model, while that of the MF layer was governed by the cake layer. The different fouling behaviours in the present invention is correlated to the unique porous microstructure of the ceramic supports. Firstly, the surface pores are mainly made by the alumina particles, which are smaller and more uniform than those formed by pore agents. This will help to reject the large oil droplets. Secondly, the inner larger hollow structure enables the overall gradient porous structure, and thus the penetrated oil droplets that smaller than the surface pores can be swept away effectively. This explained the lower oil removal efficiency and cake filtration fouling model, rather than standard pore blocking model.

The fouling model of the ceramic supports is generally dominated by the standard blocking model, while that of the MF layer is governed by the cake layer. The different fouling behaviours in this work were correlated to the unique porous microstructure of the ceramic supports. First, the surface pores have been made largely by the alumina particles being smaller and more uniform than those formed by pore-forming agents, which would help to reject the large oil droplets. Second, the inner larger hollow structure enabled the overall gradient porous structure, and thus the penetrated oil droplets that were smaller than the surface pores would be swept away effectively. This explained the relatively lower oil removal efficiency and cake filtration fouling model, rather than the standard pore blocking model. The results demonstrated the potential of the ceramic membrane supports being directly used in treating oily wastewater.

### Co-Firing of Gradient Structured Ceramic Membranes

In the asymmetrical structure, ceramic membranes consist of a macro-porous support, one or more interlayer(s) and a fine top filtration layer. Traditionally, each layer/part requires an individual “shaping/coating-drying-sintering” multistep process. As a result, the fabrication of ceramic membranes is of both time consuming and energy-extensive consumption, and the overall high cost is one of the main concerns in widening their extensive applications, although they have obvious advantages in performance and long-term stability over the polymeric counterparts.

The inventors have found that a one-step co-firing process can be performed for fabricating ceramic membranes, whereby the interlayer(s) and the filtration layer are applied on the green body of a macro-porous support, and the ceramic membranes are successfully fabricated through a single firing process. With the incorporation of a sintering additives, such as one of those silicates (kaolin nanoflakes) into the coarse alumina particle matrix, a low-temperature sintering of the macro-porous support is realized, which can match with that of the membrane layers. The functional gradient microstructure in membrane layers further minimizes the shrinkage difference between the adjacent layers, which effectively avoids the undesirable delamination and/or cracks. The new co-firing strategy greatly shortened the processing duration and reduced the energy consumption, thereby improving the production efficiency and making the ceramic membranes affordable at much lowered cost for extended application areas.

With the introduction of kaolin nanoflakes into alumina matrix, porous ceramic supports with high water permeability and mechanical strength are successfully prepared in the temperature of 1200-1400° C. The reduced temperature is well matched with that of the membrane layers, which is a precondition for the success in co-firing process. On the basis of this, co-firing of the macro-porous support and membrane layer(s) were then made. To demonstrate the feasibility of developing gradient structure, we first conducted co-firing a single-layer membrane using fine-sized alumina particles.

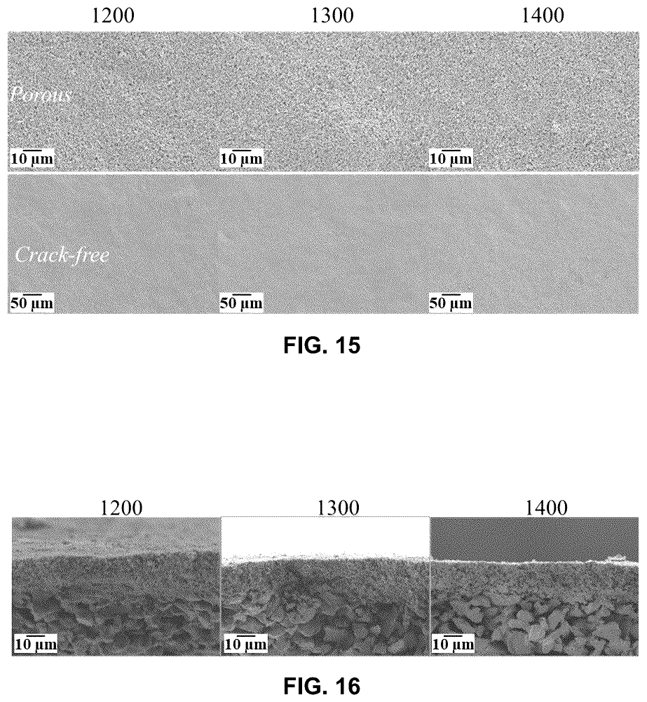

As shown in FIG. 15, the surface of these single-layer membranes co-fired at 1200, 1300 and 1400° C. is porous, smooth and crack-free. There is no obvious difference between the membranes prepared at these temperatures. The cross-section of the three single-layered membranes were examined, as shown by the SEM images in FIG. 16. The membrane layer with a thickness of ˜20 μm was observed. Significantly, a clear interface between the support and membrane layer can be well identified. The membrane layer was well-bonded on the support without notable delamination or cracks at the interface. Moreover, there is no penetration of the membrane layer into the macro-porous support. This feature helps maximize the water flux in the filtration process. As shown in Table 3, the pure water flux at 100 kPa of these membranes sintered at 1200° C. 1300° C. and 1400° C. is 2256.67±10.83 LMH. 2910.05±57.24 LMH. 3239.89±9.63 LMH, respectively. The pure water flux is much higher than that of the commercial ones (˜1700 LMH), benefiting from the interlayer-free and penetration-free features.

TABLE 3
Pure water flux and membrane resistance
of the co-fired membranes

| Temperature | Pure water flux | Rₘ |
|---|---|---|
| (° C.) | (100 kPa, LMH) | (m⁻¹) |
| 1200 | 2256.67 ± 10.83 | 2.04e11 |
| 1300 | 2910.05 ± 57.24 | 1.43e11 |
| 1400 | 3239.89 ± 9.63 | 1.78e11 |

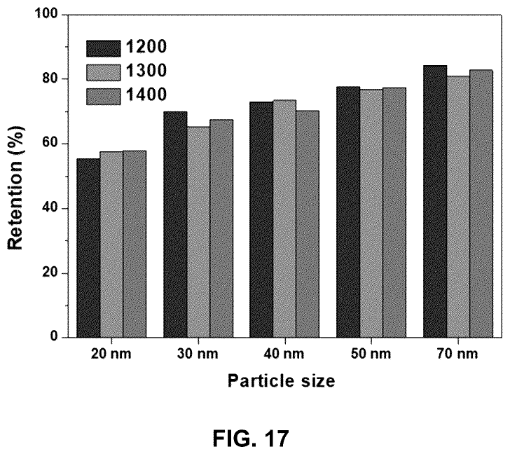

A qualified membranes require not only the high water permeability but also a good rejection ability. FIG. 17 shows the retention ability of these co-fired membranes to various-sized particles. The membranes prepared at various temperatures showed comparable retention to the given particles. With the increase in particle size from 20 nm to 70 nm, the retention gradually increased from ˜60% to over 80%. Compared with the commercial membranes prepared from the same ceramic particles by conventional sintering process, these co-fired membranes showed an even better retention to the given particle size. For example, the retention of commercial membranes to the PS particles (70 nm) was 77%, while those of these co-fired membranes are all above 80%. The particle size retention results confirm that the co-fired membranes have excellent integrity, without notable cracks or pores, which are vitally important for their applications.

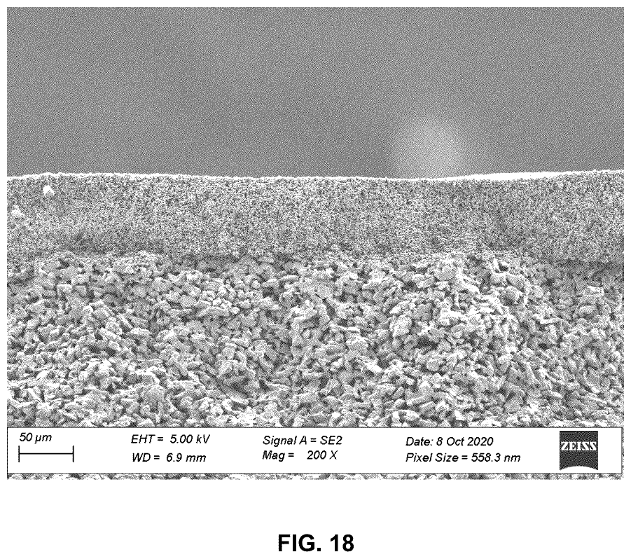

In addition, relatively large alumina particles were also coated on the green body and the membrane was co-fired at 1400° C. As seen in FIG. 18, the subsurface of the substrate was porous and crack-free. To alleviate the likely shrinkage difference between the adjacent layers, a gradient multilayer structure was proposed, where the large-, medium- and small-sized alumina particles were coated on the “green” substrate successively, followed by the co-firing process at 1400° C.

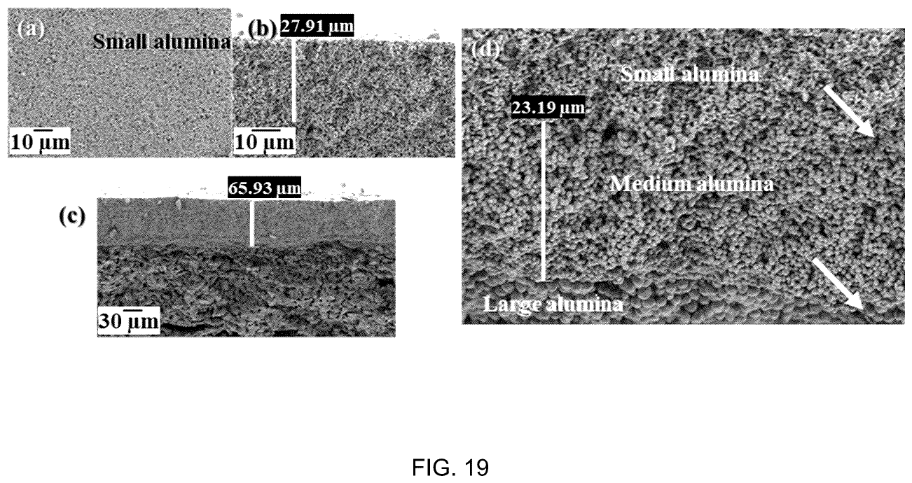

The top-layer of the gradient membrane layers are composed of the small sized particles, which thus is able to serve as the filtration layer. FIG. 19 shows (a) surface SEM image. (b-d) Cross-sectional SEM images: (b) subsurface. (c) overview, and (d) enlarged view of the interfaces between adjacent layers, of multilayered membranes co-fired at 1400° C.

As shown in FIG. 19a, the surface of the gradient membrane layer is porous and crack-free. Also, a porous microstructure is observed in the cross-section SEM image of the subsurface (FIG. 19b). The overall thickness of the gradient membrane layer was determined to be ˜65 μm (FIG. 19c). The interface between the membrane layer and the substrate is clearly observed and bonded well. Since the membrane layers are coated on the unfired “green” substrate, no penetration is observed. Also, the cracks in the subsurface of the substrate that was detected in the co-fired single-layer membrane are absent. In addition to the interface between the membrane layer and the substrate, those between the adjacent layers in the gradient membrane can be clearly identified (FIG. 19d). There is no significant penetration, suggesting that the powders are properly graded.

### CONCLUSION

Low-cost kaolin nanoflakes were used to decorate the surface of coarse alumina particles, and multi-channel flat-sheet ceramic supports were fabricated by extrusion and partial sintering. By the interfacial engineering approach, ceramic supports with high water permeability and mechanical strength were successfully prepared by sintering at 1200° C. With the increase in sintering temperature (1200° C.-1400° C.), the level of porosity was slightly reduced, while the proportion of large pores as well as the water permeance were raised. The unique phenomena were originated from the liquid phase sintering of kaolin nanoflakes, then their slow migration on the surface of coarse alumina particles and finally the aggregation at the interface. Due to the large pores between coarse alumina particles and the existence of an internal hollow structure, the ceramic support prepared at 1400° C., showed an extremely high water permeance of 9911.9±357.5 LMHB. At the same time, the flexural strength reached a high level of 109.6+4.6 MPa, which was attributed to the increased interface area and strong interfacial interaction, as evidenced by the trans-granular fracture behaviour. Besides, the alumina-based supports show excellent chemical stability and good removal efficiency for oily wastewater. This work provides an effective pathway to prepare the porous ceramic supports with both high permeation and mechanical strength at low sintering temperature through the combined regulation of pore structure and interface.

Having successfully reduced sintering temperature of the ceramic substrate, a one-step co-firing of the substrate and the membrane layers was developed. Both single layer and multilayer membranes are made by the one-step co-firing process. The gradient multilayer membranes effectively minimize the different shrinkages between the adjacent layers. As a result, a gradient multilayer membrane can be well prepared by the co-firing process. Both the surface and cross-section of the gradient membranes are crack-free, and the interfaces between the substrate and the membrane layer, as well as those between adjacent layers in the gradient membrane can be clearly identified without significant penetration. They show outstanding performance in filtration and separation applications, in terms of the enhanced water flux and good retention.

### Examples

Raw Materials Kaolin (≥98%), sodium carboxymethyl cellulose (CMC. Mw: ˜90.000), glycerol (≥99.5%), aluminum oxide powders (d₅₀≤10 μm, ≥99.5%) were purchased from SIGMA-ALDRICH. All the chemicals were used as the received without any purification treatment. Deionized water was produced by using the purification systems (Adrona B30. Adrona SIA. Latvia).

### Preparation of the Support

Raw materials including alumina (75 wt %) and kaolin (8 wt %), and the organic binder CMC (4 wt %) were weighted and mixed for 10 min at a rate of 50 rpm using a kneading machine (HIVIS MIX Model 2P-1. PRIMIX Corp., Japan). Then, deionized water and glycerol used as the solvent and the humectant, respectively, were added to the mixture, followed by a kneading (50 rpm. 30 min). After that the ceramic paste was aged in a sealed container for 48 h. Multi-channel flat-sheet green body with designed dimensions was formed by using an auger extruder (ECT KEMA GmbH. Germany). The products extruded out were transformed by a home-made roller table and naturally dried at room temperature for 48 h. The well-shaped pre-ceramics were then fired at various temperatures for 2 h with a ramping rate of 1° C./min and dwelled at various temperatures (1100-1500° C.).

### Preparation of Ceramic Membranes

To construct the membrane layers, three alumina powder slurries were prepared using alumina particles with different particle sizes (small size: 0.3-0.5 μm; medium size; 0.83 μm; large size: 1.7 μm). For each slurry, alumina powders (20 wt %) were added into the nitric acid aqueous solution (0.01 mol/L) with a stirring for 10 min followed by ultrasonic treatment at 42 kHz for 30 min. After that, methyl cellulose aqueous solution (2 wt %) were added, followed by a stirring for another 10 min. A stable and well-dispersed alumina slurry was then obtained in each case. Further, vacuum deforming was carried out to remove the air bubbles in the alumina slurry. Finally, the slurry was spray-coated on the green body of the ceramic support. To build the gradient membrane structure, the alumina slurry containing large-, medium- and small-sized particles were spray-coated, successively. After drying at room temperature for 24 h, the green body of gradient-layer membranes were sintered at various temperatures (1100-1500° C.) for 2 h.

### Characterization

Microstructures of the raw materials and samples were studied by using a field-emission scanning electron microscopy (FE-SEM, ZEISS Supra 300), which was combined with energy-dispersive-X-ray spectroscopy for elemental analysis. The thermal behavior of the pre-ceramic samples was examined by using a thermogravimetric analyzer (TGA, SDT, Q600. TA instruments, USA) at a heating rate of 10° C./min in air. A capillary flow porometer (Porometer 3G, Quantachrome, USA) was used to measure the pore size distribution, and Profill wetting liquid was used to wet and penetrate into the membrane pores. At a given fluid and pore size with constant wetting, the pressure required to force an air bubble through the pore is inversely proportional to the pore size. The flexural strength of ceramic supports was measured by a three-point bending test method (Instron 4206. Instron. USA), and four samples were tested to obtain the average strength. The level of open porosity was determined by the Archimedes method, with distilled water as the liquid medium. The shrinkage of the ceramic supports was calculated by measuring the thickness before and after sintering at room temperature. The rheology properties of the ceramic paste were measured by using the Discovery Hybrid Rheometer (TA Instruments) at 25° C. in both shear viscometry and oscillatory modes with a 40 mm dual Peltier plate. The apparent viscosity was measured as a function of shear rate using logarithmically ascending series. Small amplitude oscillatory shear measurements were performed to determine the storage (G′) and loss (G″) moduli as functions of angular frequency. G′ and G″ as functions of shear stress amplitude were measured at a constant frequency of 6.283 rad/s. X-ray diffraction (PXRD) patterns were recorded on a Bruker D8 Advance diffractometer (Cu Kα radiation). The corrosion resistance of the ceramic supports was examined by soaking them into NaOH (10 wt %) and H₂SO₄ (20 wt %) aqueous solution for 25 h. After that the samples were cleaned thoroughly in DI water using ultrasonic treatment. The mass, open porosity, flexural strength and microstructure of the corroded samples were measured and compared with that of the pristine supports.

### Pure Water Flux and Oil-In-Water (O/W) Emulsion Separation

The permeability of ceramic supports were evaluated by the pure water flux and pure water permeability using dead-end filtration. The pure water flux (J. Lm⁻²h⁻¹) was measured at various transmembrane pressures (TMPs, bar), and calculated using Equation (1), as follows:

$$J = \frac{V}{At} \qquad ( 1 )$$

where V is the volume of the permeate (L). A is the effective area of the membrane surface (m²), and t is the filtration time (h). Further, the water permeability was calculated using Equation (2), as follows:

$$Q = \frac{V}{AtP} \qquad ( 2 )$$

where P is the TMP (bar). The oil in water (O/W) emulsion with various concentration (100, 200 and 300 ppm) were prepared. The separation experiment was conducted using dead-end filtration at a TMP of 1 bar. The oil removal efficiency (Rₒᵢₗ) of the ceramic supports was calculated by using Equation (3), as follows:

$${R}_{oil} = 1 - \frac{{I}_{P}}{{I}_{F}} \qquad ( 3 )$$

Where I_{F} and Iₚ are the UV-vis absorption intensity of the feed and permeate, respectively. At the same time, the time dependent permeate was calculated using Equation (1).

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

1-39. (canceled)

40. A method of fabricating a ceramic paste, a porous ceramic support or a supported ceramic membrane, comprising:
a) mixing a ceramic powder, a clay powder and a binder to form a mixture;
b) kneading the mixture of step (a) in an aqueous or non-aqueous medium and a humectant to form a ceramic paste; and
c) aging the ceramic paste for at least 24 h;
wherein the ceramic powder is about 70 wt % to about 80 wt % in the ceramic paste;
wherein the clay powder is about 5 wt % to about 15 wt % in the ceramic paste; and
wherein the ceramic powder has an average particle size of about 5 μm to about 20 μm.

41. The method according to claim 40, wherein the ceramic powder is selected from alumina, SiC, Si₃N₄, silicates, TiO₂ or a combination thereof.

42. The method according to claim 40, wherein the clay powder is selected from kaolin, dolomite, coalgangue, kyanite, smectite, illite, chlorite, palygorskite (attapulgite), sepiolite or a combination thereof; and
wherein the clay powder has an average particle size of about 0.05 μm to about 2 μm.

43. The method according to claim 40, wherein the binder is carboxymethyl cellulose (CMC), polyvinylalcohol (PVA), polyvinyl butyral (PVB), polyvinyl pyrrolidone (PVP) or a combination thereof.

44. The method according to claim 40, wherein the binder is about 2 wt % to about 8 wt % in the ceramic paste; and wherein the solvent is about 5 wt % to about 20 wt % in the ceramic paste.

45. The method according to claim 40, wherein the humectant is glycerol, L-pyrrolidone carboxylic acid-Na, polyhydric alcohol, or a combination thereof; and
wherein the humectant is about 0.1 wt % to about 1.5 wt % in the ceramic paste.

46. The method according to claim 40, wherein the ceramic paste is free of a pore forming agent.

47. The method according to claim 40, wherein the aging step is performed in an enclosed environment.

48. The method according to claim 40, the method further comprising a step (d) (after step (c)) of extruding the aged ceramic paste in order to form an extruded aged ceramic green body and drying the extruded aged ceramic green body for at least 24 h; and wherein the extruded aged ceramic green body comprises an asymmetric porous structure having an inner body conterminous to an outer surface; and wherein the inner body comprises a plurality of voids.

49. The method according to claim 48, further comprising a step (e) of at least partially sintering the extruded aged ceramic green body at about 1000° C. to about 1500° C., for at least 2 h to form a porous ceramic support; wherein a thickness of the porous ceramic support decreases by less than about 8% after the sintering step.

50. The method according to claim 49, further comprising:
e) coating at least one layer of a ceramic slurry on a surface of the extruded aged ceramic green body and drying the coated layer of ceramic slurry to form a membrane green body; and
f) at least partially sintering the membrane green body and the extruded aged ceramic green body at about 1000° C. to about 1500° C. to form the supported ceramic membrane;
wherein the ceramic slurry comprises ceramic powder at about 10 wt % to about 40 wt % in the slurry; and
wherein the ceramic powder in the ceramic slurry has a particle size of about 0.05 μm to about 5 μm.

51. The method according to claim 50, wherein the ceramic slurry comprises nitric acid at a concentration of about 0.01 mol/L to about 0.5 mol/L, and/or wherein the ceramic slurry further comprises methyl cellulose at about 1 wt % to about 5 wt % in the slurry.

52. The method according to claim 50, wherein the step of coating at least one layer of ceramic slurry on a surface of the extruded aged ceramic green body and drying the coated layer of ceramic slurry to form a membrane green body (step e)) comprises:
i) coating a first layer of a first ceramic slurry on the surface of the ceramic green body and drying the coated layer of the first ceramic slurry to form a first membrane green body, the first membrane green body having an exposed surface distal from the surface of the ceramic green body; and
ii) coating a second layer of a second ceramic slurry on the exposed surface of the first layer and drying the coated layer of the second ceramic slurry to form a second membrane green body;
wherein the first layer of ceramic slurry comprises ceramic powder having a particle size of about 1 μm to about 5 μm, and wherein the second layer of ceramic comprises ceramic powder having a particle size of about 0.05 μm to about 1.5 μm.

53. A ceramic paste, comprising:
a) a ceramic powder at about 70 wt % to about 80 wt % in the ceramic paste;
b) a clay powder at about 5 wt % to about 15 wt % in the ceramic paste;
c) a binder at about 2 wt % to about 8 wt % in the ceramic paste;
d) a humectant at about 0.1 wt % to about 1.5 wt % in the ceramic paste; and
e) an aqueous medium;
wherein the ceramic powder has an average particle size of about 5 μm to about 20 μm;
wherein the ceramic paste has a viscosity of about 1×10⁴ Pa·s to about 5×10+Pa·s at a shear rate of about 10⁻¹ s⁻¹; and
wherein the ceramic paste has a yield flow pressure of about 1000 Pa to about 1500 Pa.

54. A ceramic support, comprising:
a) a ceramic at about 85 wt % to about 95 wt % in the ceramic support; and
b) a clay at about 5 wt % to about 15 wt % in the ceramic support;
wherein the ceramic has an average particle size of about 5 μm to about 20 μm; and
wherein the ceramic support comprises an asymmetric porous structure having an inner body conterminous to an outer surface;
wherein the inner body further comprises a plurality of voids;
wherein the ceramic support has a porosity level of about 30% to about 50%.

55. The ceramic support according to claim 54, wherein the ceramic support is characterised by at least one of the following:
a) a pore size distribution of about 0.3 μm to about 3.5 μm;
b) a multimodal pore size distribution;
c) the void having a diameter of about 0.5 μm to about 100 μm; and
d) the outer surface having a thickness of about 40 μm to about 100 μm.

56. The ceramic support according to claim 54, wherein when the clay is kaolinite, the clay has a phase composition comprising of mullite, cristobalite, or a combination thereof.

57. The ceramic support according to claim 54, further comprising at least one ceramic membrane layer coated on a surface of the ceramic support;
wherein the at least one ceramic membrane layer has a thickness of about 3 μm to about 100 μm.

58. The ceramic support according to claim 57, wherein at least two ceramic membrane layers are coated on the surface of the ceramic support, each of the two ceramic membrane layers in contact with each other to form a multilayered ceramic membrane;
wherein each of the at least two ceramic membrane layers comprises ceramic particles of a different particle size.

59. The ceramic support according to claim 54, having a retention for 20 nm particles of at least about 50%.
